(19) United States
(12) Patent Application Publication
(10) Pub. No.: US 2007/0109974 A1
(43) Pub. Date: May 17, 2007

(54) Passive optical network unit management and control interface support for a digital subscriber line network

(76) Inventors: Dennis Cutillo, Sanford, FL (US); Ian Donaldson, Deltona, FL (US); Kiet V. Truong, Oviedo, FL (US); Matthew Brocco, DeBary, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/581,650

(22) PCT Filed: Nov. 19, 2004
(86) PCT No.: PCT/EP04/53021

§ 371 Date: Jun. 1, 2006

Related U.S. Application Data
(60) Provisional application No. 60/525,983, filed on Dec. 1, 2003.
(60) Provisional application No. 60/540,990, filed on Feb. 2, 2004.
(60) Provisional application No. 60/570,575, filed on May 13, 2004.

(51) Int. Cl. H04L 12/28

(52) U.S. Cl. 370/254; 370/493

(57) ABSTRACT

An optical network unit for managing digital subscriber line (xDSL) connections to a passive optical network. According to one embodiment, the optical network unit comprises data structures in the form of managed entities that are issued by the optical network unit for managing each of the xDSL connections. Each managed entity is associated with one or more network features and comprises one or more elements further comprising relationships to other managed entities, attributes, actions, and notifications. The passive optical network provides a data connection between the individual xDSL subscriber connections and external networks, such as the Internet and a switched telephone network.

### CROSS-REFERENCE TO RELATED APPLICATIONS

The present application claims the benefit of the provisional patent application filed on Dec. 1, 2003, and assigned application No. 60/525,983, the provisional patent application filed on Feb. 2, 2004, and assigned application No. 60/540,990 and the provisional patent application filed on May 13, 2004, and assigned application No. 60/570,575.

### FIELD OF THE INVENTION

The invention relates generally to the management and control of optical networks, and specifically to the management and control of a passive optical network operative providing digital subscriber line (DSL) service (e.g., an asymmetric digital subscriber line service (ADSL) or very high speed digital subscriber line service (VDSL)).

### BACKGROUND OF THE INVENTION

The use of fiber optic cables to carry information signals continues to grow in popularity worldwide. Digital information signals modulate light traveling on the fiber optic cable between a source node and a receiving node. As is well known, fiber optic cable has a much higher information carrying capacity than copper wire, including the ubiquitous unshielded twisted copper pair commonly used for providing dial-up telephone service. As fiber continues to be deployed throughout telecommunications networks, its advantages over copper accrue to the user. Generally, fiber exhibits a higher bandwidth and lower signal losses than copper conductors. Fiber is also more reliable and has a longer useful life than copper conductors. Since fiber does not emit any electromagnetic radiation, it is a more secure transmission medium than copper.

A passive optical network (PON), including for example a B-PON (broadband passive optical network) or a G-PON (gigabit passive optical network), provides multiple data transmission paths each capable of delivering high-bandwidth data services to multiple users. An exemplary B-PON comprises 32 or extensible to 64 such data paths, each data path comprising one fiber optic cable. A G-PON comprises, for example, 64 or 128 data paths. A standardized PON protocol controls and manages the transmission and reception of signals across the passive optical network.

In addition to the fiber optic cable, the PON optical distribution network (ODN), further comprises optical splitters and combiners for directing information signals propagating between an optical line terminal (OLT) at a network head end and a plurality of optical network units (ONU's) located at or proximate a subscriber's site.

According to current standards, the fiber optic path on a PON network operates at data rates of 155 Mbps, 622 Mbps, 1.25 Gbps, and 2.5 Gbps. Bandwidth allocated to each customer from this aggregate bandwidth can be statically or dynamically assigned to support voice, data, video and multimedia applications.

The conventional PON topology comprises a shared upstream signal path and a broadcast downstream path. Downstream data, including an address header, is broadcast from the OLT to all ONU's. Each ONU identifies the data intended for it, using an address matching process.

Use of a broadcast mechanism for upstream traffic requires a scheme to avoid data collisions. One technique for managing the upstream traffic employs a TDMA (time division, multiple access) protocol in which dedicated transmission time slots are granted to each ONU. All ONU's are time synchronized and each transmits data only during its assigned time slot. Upstream data received by the OLT from an ONU is processed and forwarded to its intended destination beyond the PON.

Typically, transmitters employed in fiber optic communication systems emit light at one of three wavelengths: 1310 nanometers, 1490 nanometers and 1550 nanometers, where the specified wavelength is approximately at the center of the signal bandwidth. Signals at these wavelengths experience relatively low attenuation as they propagate through the fiber and therefore represent good choices for fiber optic communications.

A network architecture reference model for the B-PON is described in the International Telecommunications Union (ITU) Specification ITU-T G.983.1, entitled, Broadband Optical Access Systems Based on Passive Optical Networks (PON), which is incorporated herein by reference. Additional information can be found in related ITU specifications G.983.x, which are incorporated by reference. G-PON reference models are described in the International Telecommunications Union Specifications ITU-T G.984.1 through 984-4, which is also incorporated by reference.

The provision of xDSL services by a telephone company to subscribers is known in the art. According to current specifications, xDSL can provide up to four channels of service, including, for example, telephone service, internet data services and video services. As is also known, the data rate of the xDSL service is limited by the distance between the subscriber and the telephone company central office (for telephone company provided xDSL service). Many subscribers do not qualify for xDSL service because this distance is greater than a minimum distance established by the provider, and therefore cannot enjoy the wide-bandwidth/high-speed services available with xDSL service.

### BRIEF SUMMARY OF THE INVENTION

According to one embodiment, the present invention comprises a method for managing a network providing data services to a subscriber, wherein the network comprises an OLT and an ONU connected to the OLT via a passive optical network, wherein the ONU is connected to the subscriber through an xDSL connection. The method comprises providing a plurality of managed entities for managing the ONU, wherein the plurality of managed entities further comprise ADSL managed entities for managing an ADSL connection between the ONU and the subscriber, and VDSL managed entities for managing a VDSL connection between the ONU and the subscriber; managing the network through one or more of the plurality of managed entities; and communicating data and network management information between the OLT and the ONU in response to the managed entities.

According to another embodiment, an OLT manages a passive optical network comprising a plurality of ONU's each ONU providing a plurality of xDSL links and each link comprising a plurality of channels. The OLT comprises a controller for managing the plurality of channels of the plurality of xDSL links by issuing managed entities to the ONU, wherein each managed entity comprises a link identifier and a channel identifier. The OLT further comprises a transceiver for sending data to and receiving data from the ONU's.

### BRIEF DESCRIPTION OF THE DRAWINGS

The foregoing and other features of the invention will be apparent from the following more particular description of the invention, as illustrated in the accompanying drawings, in which like reference characters refer to the same parts throughout the different figures. The drawings are not necessarily to scale, emphasis instead being placed upon illustrating the principles of the invention.

FIG. 1 illustrates a fiber to the premises (FTTP) network to which the teachings of the present invention can be applied.

FIG. 2 illustrates the control elements of the network of FIG. 1 that implement the OMCI protocol of the present invention.

FIGS. 3 and 4 illustrate elements of the ONU of FIGS. 2 and 3.

FIG. 5 illustrates an information channel identification scheme according to one embodiment of the present invention.

FIG. 6 illustrates information channels provided by an xDSL modem.

FIG. 7 illustrates principal elements of an OLT of FIGS. 2 and 3.

FIG. 8 illustrates OMCI managed entities according to the teachings of the present invention for an ADSL network.

FIG. 9 illustrates OMCI managed entities according to the teachings of the present invention for a VDSL network.

### DETAILED DESCRIPTION OF THE INVENTION

Before describing in detail the particular method and apparatus for OMCI support of ADSL, VDSL and xDSL subscriber line interfaces according to the present invention, it should be observed that the present invention resides primarily in a novel and non-obvious combination of elements and process steps. So as not to obscure the disclosure with details that will be readily apparent to those skilled in the art, certain conventional elements and steps have been presented with lesser detail, while the drawings and the specification describe in greater detail other elements and steps pertinent to understanding the invention.

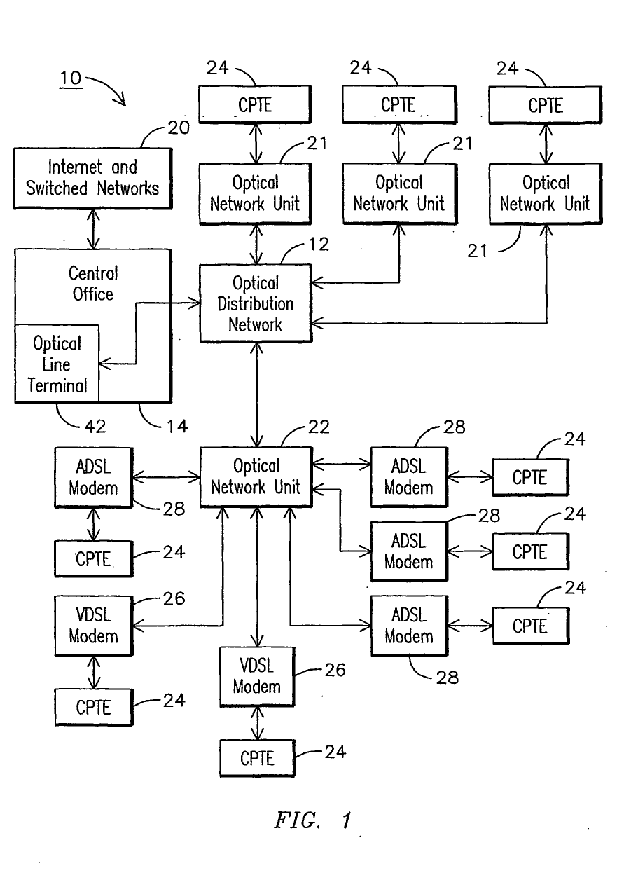

FIG. 1 illustrates a fiber to the premises (FTTP) network 10 comprising an optical distribution network 12 (also referred to or having the attributes of a passive optical network (PON), a broadband passive optical network (B-PON) or a gigabit passive optical network (G-PON)) providing an optical communications link between a central office 14 of a telecommunications provider and users or subscribers. As described below, the optical distribution network 12 provides various types of service, e.g., FTTH (fiber to the home), FTTBusiness (fiber to the business), FTTB/C (fiber to the building/curb) and FTTCab (fiber to the cabinet).

According to one embodiment of the FTTP network 10, information signals are carried over the network at wavelengths of 1310 nm, 1490 nm and 1550 nm. The 1310 nm signal is used for upstream traffic, and the 1490 and 1550 signals for downstream traffic. Multimedia and video signals are carried at 1490 nm while data and telephone service is provided on 1550 nm.

Voice, data, video and multimedia broadband services are supplied from the Internet and switched networks 20 connected to the central office 14 for distribution to users through the PON or optical distribution network 12. The Internet and switched networks 20 are representative of various networks capable of sending information to and receiving information from the users. These networks, which are commonly known to those skilled in the art, include: video and multimedia networks, TDM/PTN networks, ATM networks, and IP networks. Thus at the user's site, the FTTP network 10 provides multiple information services including: video and multimedia signal delivery, telephone service and Internet access.

A single-family optical network unit 21 (also referred to as a single family unit, SFU) is mounted on or proximate the premises of a single family home or a commercial building occupied by a single business, for providing a single user with access to the optical distribution network 12. Since the optical distribution network (the fiber optic cable) extends to the single user premises, the network is referred to as a fiber to the premises (FTTP) or a fiber to the building/curb (FTTB/C) network.

At each user site a customer premises terminal equipment (CPTE) 24 connects to an appropriate output port (channel) of the ONU 21. According to one embodiment, the ONU 21 provides a video port for connection to video-related customer premises terminal equipment and a telephone service port for connection to customer premises telephone equipment. The ONU 21 also provides an Ethernet output port for connection to customer premises data terminal equipment, such as a computer. The user's site may further include a network router (not shown) for permitting more than one user to simultaneously access the optical distribution network 12 via the router and the ONU 21.

An optical network unit (ONU) 22 (also referred to as a multiple distribution unit, MDU) provides xDSL service to a plurality of subscribers or users via an ADSL or a VDSL connection (also referred to as a port) on the ONU 22 to a corresponding VDSL modem 26 or ADSL modem 28. The ONU 22 also supports other DSL-type connections, generically referred to as xDSL connections. The ONU 22 functions as an access multiplexer, providing multiple xDSL subscribers with access to the optical distribution network 12 via an xDSL connection between the ONU 22 and the VDSL/ADSL modem 26/28. The ONU thus provides functionality associated with a digital subscriber line access modem (DSLAM).

According to the terminology employed in certain networks and by certain network product vendors, the ONU 21 is referred to as an ONT (optical network terminal) as it lacks the capability to provide an xDSL connection and is thus distinguished from the ONU 22, which does provide xDSL connectivity.

Each ONU output port (in one embodiment, the ONU 22 comprises 24 ports) provides multiple service channels, including four channels (also referred to as bearer channels) in one embodiment, including channels providing video, telephone and Internet data services. The CPTE 24 connected to the VDSL/ADSL modem 26/28 represents equipment that responds to the channel signals, e.g., a display for displaying the video signals, telephone equipment responsive to the telephone channel and a computer responsive to the Internet data services channel.

The optical network unit 22 is located proximate the users or subscribers, e.g., in a telephone closet of a multi-dwelling or multi-office complex, and is connected to the VDSL/ADSL modems 26/28 via an appropriate conductor suitable for carrying xDSL signals. A twisted pair of copper conductors is one example of a suitable conductor.

As described above, xDSL connections between the subscriber and a telephone company central office are limited to distances over which a high quality/high data rate signal can be carried. By extending the optical distribution network 12 to the subscriber's premises, as shown in FIG. 1, terminating the network 12 in the ONU 22 and controlling the optical distribution network and its associated devices according to the ONT management and control interface support for xDSL lines as set forth herein, xDSL service is made available to subscribers who are located farther from the central office than the recommended distance. With this configuration, the length of the subscriber's xDSL line is now effectively the distance between the premises-located ONU 22 and the CPTE 24 within the subscriber's space in the premises. Thus, with respect to the provision of xDSL services, the central office, and the functionality associated therewith, has effectively been relocated to the subscriber's premises.

For an ADSL connection, the optical transceiver in the ONU 22 is referred to as an ATU-C transceiver unit, wherein the “C” represents the “central office.” Similarly, for a VDSL connection, the transceiver in the ONU 22 is referred to as an VTU-C or VTU-O transceiver unit. The optical transceiver at the remote end, i.e., within the ADSL or VDSL modem 28 or 26, is referred to as a remote end ADSL transceiver unit (ATU-R) or a remote end VDSL transceiver unit (VTU-R).

Although it is theoretically possible to extend the fiber optic cable to each subscriber in a multi-subscriber premises, and thus utilize a single-family optical network unit 21 as described above to terminate the fiber, it is commercially more pragmatic to extend the fiber to the premises, terminate the fiber with an ONU 22, and use existing copper conductors within the premises to provide each subscriber with an xDSL connection between the ONU 22 and the subscribers space within the premises. Installing fiber optic cable to each subscriber in the premises would be an expensive and labor-intensive undertaking.

Although only a single ONU 22 is shown in FIG. 1, those skilled in the art recognize that multiple ONU's 22 are connected to the optical distribution network 12 to provide telephone, multimedia and data services to the users via an xDSL connection to an xDSL modem, e.g., the VDSL/ADSL modems 26/28.

The central office 14 comprises an optical line terminal (OLT) 42 operative as a optical transceiver for broadcasting data, multimedia and telephone signals to the ONU's 22 and for receiving data, multimedia and telephone signals from the ONU's 22 that originated from a CPTE 24.

The OLT 42 also operates as a network manager for managing the ONU's 22, executing its network management functions in accordance with an ONT management and control interface (OMCI) supporting xDSL subscriber lines of the present invention. By using the managed entities of the OMCI interface as set forth herein, the OLT 42 initializes, terminates and monitors the ONU's 22, e.g., establishing and releasing connections across the ONU's, managing the xDSL user interface at each ONU 22 and requesting configuration information and performance statistics from the ONU's 22. The OLT 42 manages upstream and downstream modulation and bandwidth allocation and executes rules and policies for classifying and prioritizing communications with the ONU's 22, and thus with the subscribers through the ADSL modems 28 and the VDSL modems 26.

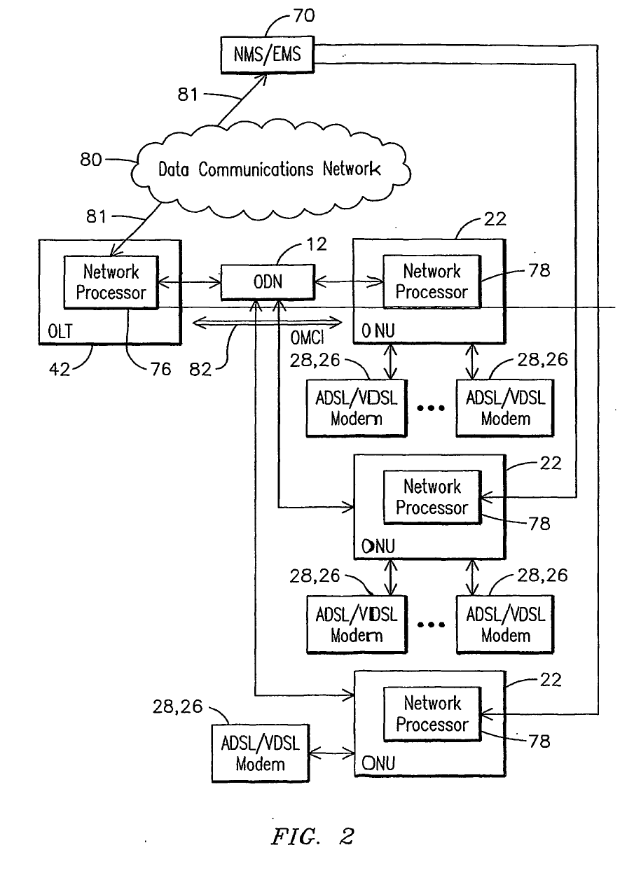

An exemplary system management architecture is illustrated in FIG. 2. A network management system/element management system (NMS/EMS) 70 operates as a high-level network manager using the simple network management protocol (SNMP), for example, to communicate with a network processor 76 (including memory for storing application software and data for use by the network processor) within the OLT 42 via a data communications network 80. Within the OLT 42, the network processor 76 receives SNMP instructions from the NMS/EMS 70 via a link 81 over the data communications network 80 (i.e., the OLT 42 implements a network agent function with respect to the network management function implemented by the NMS/EMS 70), translates the instructions into one or more managed entities of the OMCI according to the present invention, and issues a management request against a particular managed entity instance to the network processor 78 within the ONU 22 via the optical distribution network or PON 12. The OLT 42 also issues management requests (against a specific instance of a specific managed entity) to the ONU's 22 without prompting from the NMS/EMS 70. The OLT 42 thus operates as a network manager with respect to the ONU 22, which functions as a network agent. A single OLT 42 employs multiple instances of the OMCI managed entities as set forth below to control multiple ONU's.

The network management information is carried by a PON channel dedicated to network management information. The other PON channels carry data, video, telephone service, etc. In one embodiment, the PON channel carrying the network management information employs ATM (asynchronous transfer mode) network technologies and standards, although the present invention is not restricted to use with ATM. In another embodiment (for example, a GPON) ATM or GEM standards are utilized. A double arrowhead 82 indicates that the OMCI interface, as set forth herein, is the mechanism through which network management is accomplished between the OLT 42 and the ONU's 22

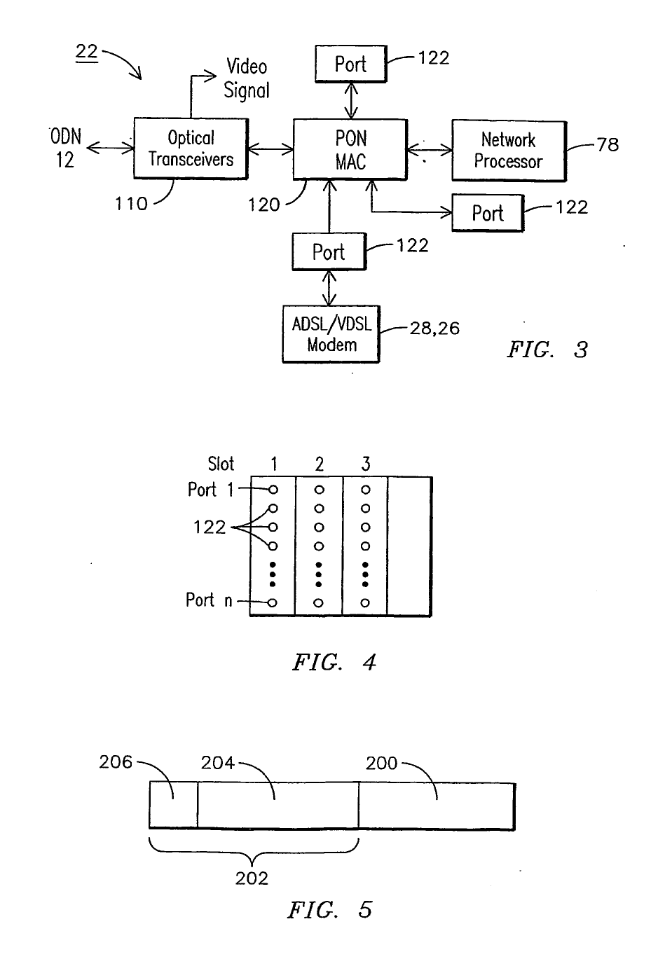

FIG. 3 illustrates details of an ONU 22, including an optical transceiver 110 for receiving optical signals from the ODN 12 and converting the optical signals to electrical signals for transmission to the ADSL/VDSL modems 28/26. The optical transceiver 110 also splits the video signal, which in one embodiment comprises broadcast and cable television signals.

The optical transceiver 110 supplies input signals to a PON media access controller (MAC) 120 for processing the signals under control of the network processor 78. Signals received by the ONU 22 are identified as to destination and forwarded from the PON MAC 120 to an appropriate output port 122, which is in turn connected to the ADSL/VDSL modem 28/26. As is known in the network art, processing of the signals is carried out based on information contained within the signal or within a control channel related to the signals.

In one embodiment, the PON MAC comprises 24 ports each for connection to one of the ADSL/VDSL modems 28/26. Each ONU output port provides multiple service channels, including four channels in one embodiment, e.g., channels providing video, telephone and Internet data services to the subscriber or user. The multiple ports of the ONU permit multi pie simultaneous uses of the digital subscriber line.

FIG. 4 illustrates a back panel of an ONU constructed according to one embodiment of the present invention, including slots 1, 2 and 3, each slot further comprising a plurality of n ports 122. The subscriber's ADSL/VDSL modem 28/26 is connected to one port 122 through an ADSL/VDSL line, with each port (or line) providing multiple service channels to the subscriber as described above.

Certain of the managed entities described below are channel-specific, that is, the managed entity sets forth one or more attributes of a specific channel. Thus, the specific channel must be identified in the managed entity, further requiring identification of the slot and port with which the channel is associated. According to one embodiment of the present invention, the channel identification within the managed entity comprises a right byte 200 (see FIG. 5) for identifying the port, and a left byte 202 further comprising six bit positions (identified by a reference character 204) for identifying the slot, and two bit positions (identified by a reference character 206) for identifying the channel.

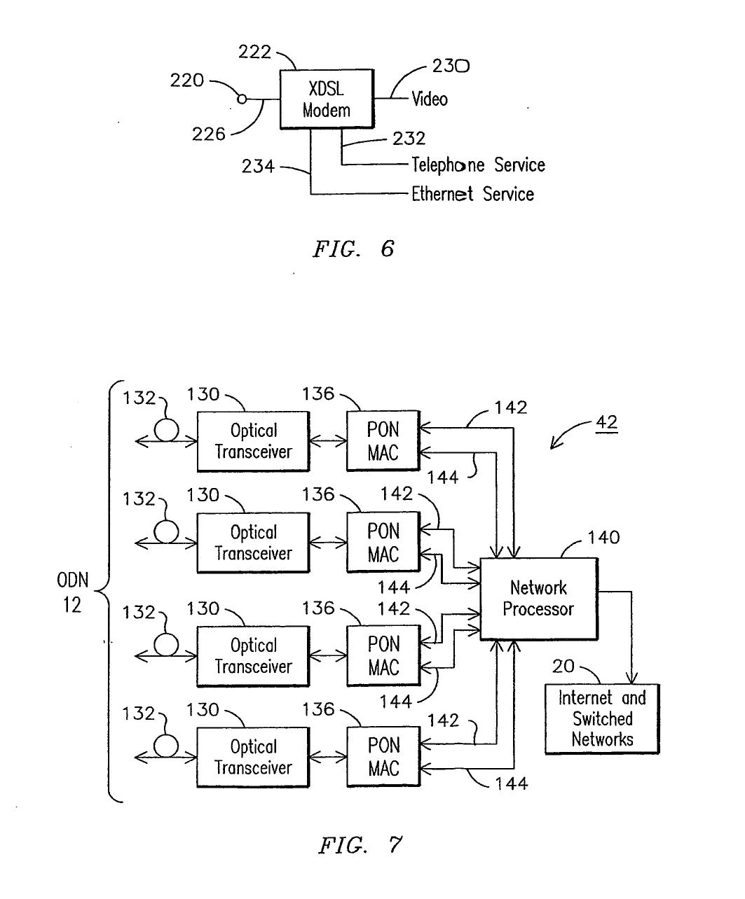

FIG. 6 illustrates a port 220 connected to an xDSL modem 222 (for example, an ADSL modem 28 or a VDSL modem 26) via a line 226. The port 220 provides three service channels, a video channel on a conductor 230 through which a subscriber can receive video services when the conductor 230 is connected to a suitable video receiving device (not shown), a telephone service channel on a conductor 232 through which the subscriber can receive telephone services when the conductor 232 is connected to a telephone apparatus, and an Ethernet service channel on a conductor 234 through which the subscriber can receive Ethernet data services when the conductor 234 is connected to a data receiving/transmitting apparatus such as a computer.

FIG. 7 illustrates certain details of an exemplary OLT 42, comprising a plurality of optical transceivers 130 each connected to a channel of a fiber optic cable 132 of the ODN or PON 12. Although only four optical transceivers 130 are shown, those skilled in the art recognize that the OLT 42 can support a substantial number of fiber optic PON ports as required by the network installation. Each optical transceiver 130 is bidirectionally responsive to a PON MAC 136 that is further responsive to a network processor 140.

The network processor 140 receives data intended for a user from the Internet and switched networks 20, processes the data and supplies data to the appropriate PON MAC 136 via a data conductor 142. The PON MAC 136 configures the data to be transmitted over the PON 12 according to the PON network protocol and supplies the data to the optical transceivers 130 for conversion to optical signals.

Data received from the user or subscriber by the optical transceiver 130 is converted to electrical signals and supplied to the PON MAC 136. The PON MAC 136 converts the data to the appropriate network protocol for transmission to the Internet and switched networks 20.

The network processor 140 also controls each PON MAC 136 via control signals supplied to the PON MAC 136 over a control conductor 144.

As is known by those skilled in the art, there are many network features or operating parameters that must be specified and controlled to effectively manage the network and permit the effective exchange of data over the network. According to the teachings of the present invention, this network control function is executed by a plurality of managed entities as described further below. The elements of each managed entity include network attributes that are to be controlled, monitored, etc.

The ONT management and control interface according to the teachings of the present invention provides management and control of the ONU's 22, and in turn the xDSL connections to the subscribers in the following areas: configuration management, fault management, performance management, and security management. Configuration management provides functions to provision (e.g., create, set or change) control, identify, collect data from, and provide control data to the ONU's 22. The OMCI protocol supports limited fault management primarily related to providing failure indications.

To manage the ONU's 22, the OLT creates a new instance of a managed entity whenever a new xDSL subscriber line is created, reads an instance of a managed entity to obtain network performance information and changes an instance of a managed entity whenever it is desired to change a profile or configuration of a network line or channel. These latter two OLT functions are actions against a specific instance of a managed entity that was previously created, i.e., when the line or channel was activated.

According to the network control art, a management information base (MIB) defines network-managed entities (managed objects) for permitting a network manager to configure and man age a network resource. In one embodiment of the present invention, the network resource comprises the xDSL connections interfacing with the ONU's 22 and the manager comprises the OLT 42. Each network resource has a corresponding configuration object (managed entity) instance that contains all configuration and operational parameters and hardware interfaces necessary to configure and manage the resource, operate the resource, interact with the network manager and describe a present state of the resource. The MIB managed entities also provide alarms and notifications that are to be reported for each managed resource and cause resource identification information (e.g., serial number or functional description) to be provided by the managed resource. In response to certain managed entities, the managed resource collects resource-operating information to be stored for later retrieval by the network manager.

Upon activation of an xDSL connection (the managed resource) to the PON, an MIB is instantiated for that xDSL connection. All control interactions between the xDSL connection are handled by the manager (the OLT 42). The network processor 78 within the ONU 22 configures the xDSL connection by processing certain managed entities of the MIB. During operation, the xDSL connection is managed by other MIB managed entities.

xDSL connection performance information requested by certain managed entities is collected by the ONU 22 and can be stored within the ONU 22 or buffered in the OLT 42. In one embodiment, performance data during the most recent 15-minute interval is buffered in the OLT 42 until over-written by more recent performance data. The performance data can be retrieved by the EMS/NMS 70 from the OLT 42 for higher level network performance evaluation.

Any resource (such as a modem) that supports the MIB and its managed entities can be successfully employed in the network and interfaced to other network devices (such as the network manager), irrespective of the device's processes and components that implement the managed entities, since from a network administration perspective all such devices are identical. Thus devices manufactured by different vendors can successfully interoperate if the devices support the MIB. As related to the present invention, devices that support the ONT management and configuration interface for xDSL lines of the present invention can successfully interoperate with other such devices and can be successfully controlled by the OLT 42.

The present invention teaches an OMCI interface comprising a plurality of managed entities for a PON operating with an xDSL connection (e.g., an ADSL or a VDSL connection) for servicing users. Additional information can be found in the specification document ITU-T G.983.10, entitled B-PON ONT Management and Control Interface (OMCI) Support for Digital Subscriber Line Interfaces, which is hereby incorporated by reference. The OMCI managed entities for a PON network are described in an International Telecommunications Union specification document referred to as ITU-T G.983.2 and entitled ONT Management and Control Interface Specification for ATM PON, which is hereby incorporated by reference. The managed entities for a G-PON network are set forth in ITU-T G.948.4, which is also incorporated by reference. Additional references herein incorporated by reference include: ITU-T G.983.1 entitled Broadband Optical Access Systems Based on Passive Optical Networks; ITU-T G.983.8 entitled B-PON OMCI Support for IP, ISDN, Video VLAN Tagging, VC Cross-Connections, and Other Select Functions; ITU-T G.997.1 entitled Physical Layer Management for Digital Subscriber Line Transceivers (including its Amendment 1); IETF RFC 3728 entitled Definitions of Managed Objects for Very High Speed Digital Subscriber Lines; IETF RFC 2662 entitled Definition of Managed Objects for ADSL Lines; IETF RFC 3440 entitled Definitions of Extension Managed Objects for Asymmetric Digital Subscriber Lines; ITU-T G.992.1 entitled Asymmetric Digital Subscriber Line (ADSL) Transceivers; ITU-T G.992.2 entitled Splitterless Asymmetric Digital Subscriber Line (ADSL) Transceivers; ITU-T G.992.3 entitled Asymmetric Digital Subscriber Line (ADSL) Transceivers-2 (ADSL2); ITU-T G.992.5 entitled Asymmetric Digital Subscriber Line (ADSL) Transceivers-Extended Bandwidth ADSL2 (ADSL2plus); ITU-T G.994.1 entitled Handshake Procedure for Digital Subscriber Line (DSL) Transceivers; ITU-T T.35 entitled Procedure for the Allocation of CCITT Defined Codes for Non-Standard Facilities; IETF draft entitled Definitions of Managed Object Extensions for Very High Speed Digital Subscriber Lines (VDSL) Using Single Carrier Modulation (SCM) line Coding; IETF draft entitled Definitions of Managed Object Extensions for Very High Speed Digital Subscriber Lines (VDSL) Using Multiple Carrier Modulation (MCM) Line Coding; DSL Forum TR-057 entitled VDSL Network Element Management; and ITU-T Recommendation G.997.1.

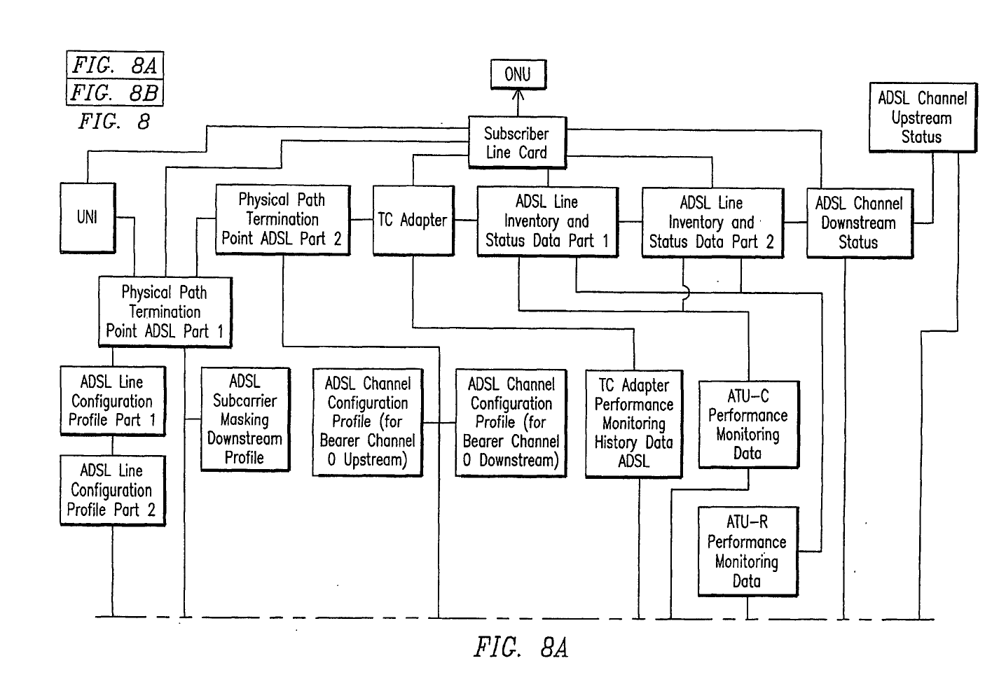

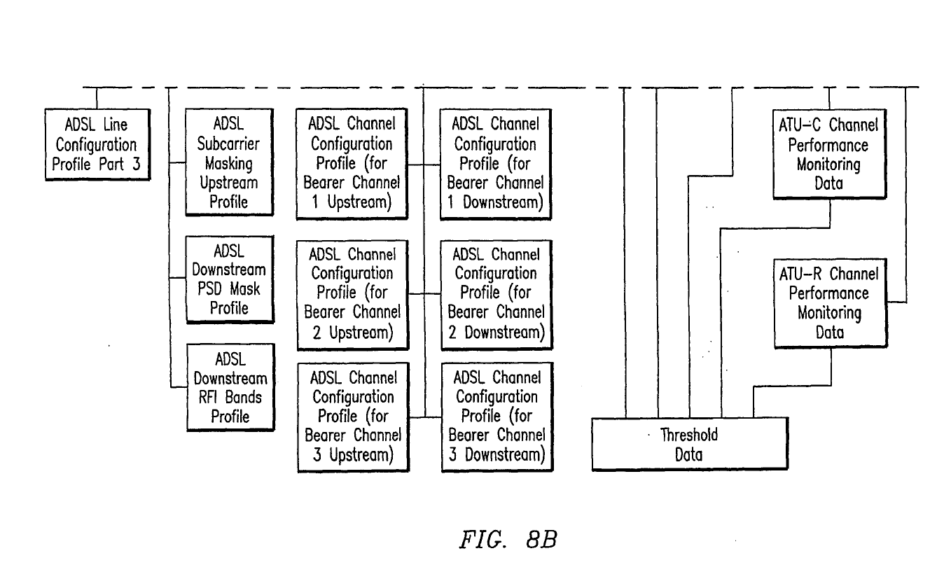

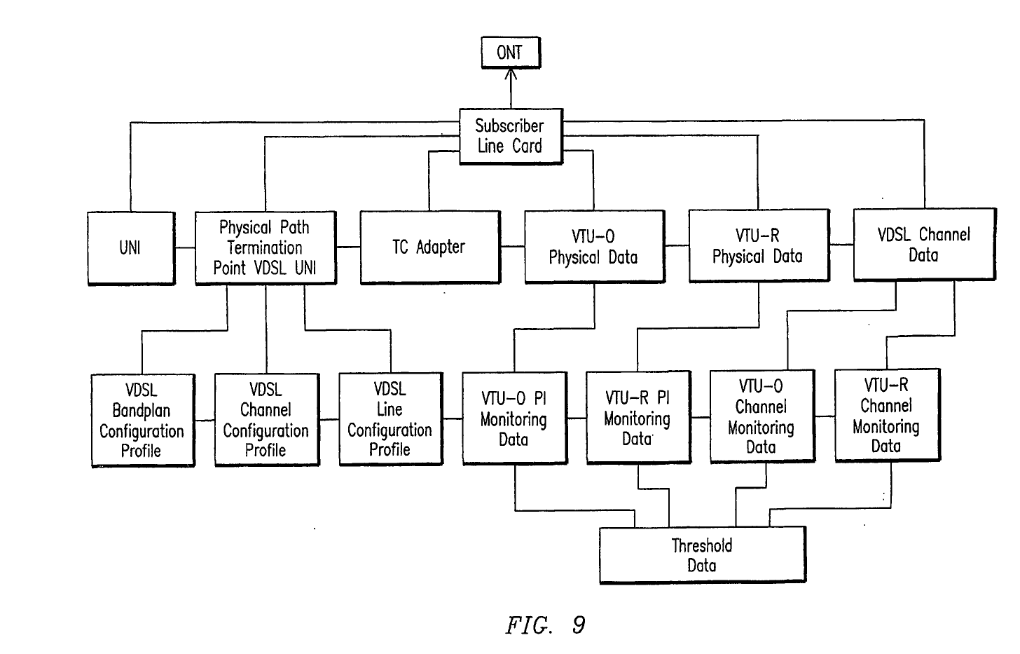

FIG. 8 illustrates the OMCI managed entities for the ADSL interface and their hierarchical relationship to each other. FIG. 9 illustrates the OMCI managed entities for the VDSL interface and their hierarchical relationship to each other. In both FIGS. 8 and 9 the numerals proximate each line connecting an origin managed entity to a destination managed entity have the format x . . . y, i.e., there are between x and y instances of the origin managed entity in the destination managed entity.

The various features (i.e., relationships, attributes, actions, notifications and alarms) of each managed entity for the PON/ADSL interface and the PON/VDSL interface are described in detail herein, but the claims of the present application are not limited to the specific implementation details set forth. Instead, the details presented are merely exemplary embodiments, as one skilled in the art recognizes that the managed entities can be applied to various PON/ADSL and PON/VDSL interfaces according to different implementation details. For example, certain attributes of certain managed entities are described as comprising a specified number of bits in the MIB. This number can be increased or decreased according to an application of the present invention to a specific PON/ADSL or PON/VDSL network interface, although interoperability with other network devices may be impaired.

In one embodiment of the present invention a data cell size limits the length of each managed entity, e.g., each managed entity (and data packet) is limited to a cell size of 53 bytes.

To minimize the number of managed entities that must be communicated over the network to effect a network management function, the various network attributes of the managed entities have been partitioned and combined such that related attributes (i.e., those attributes associated with related network features) are included within one managed entity, to the extent possible based on the permitted size of a managed entity (53 bytes in one embodiment). Where the managed entity size is insufficient to contain all such related attributes, the attributes are distributed over a plurality of associated managed entities, where the association between such managed entities is indicated by reference to a part or subset of the managed entity, e.g., part 1, part 2, etc. The ADSL line configuration profile managed entity is one such example, comprising part 1, part 2 and part 3, each part defining certain attributes associated with the configuration profile of an ADSL line. Also, according to one embodiment of the present invention, channel attributes are grouped into one or more channel-related managed entities and line attributes are grouped into one or more line-related managed entities.

Within the OMCI protocol of the present invention, managed entities are classified into compliance levels that govern the features and processes of a network device. Network devices that implement the required managed entities (identified in Tables 1 and 10 below by a “CR” identifier) are interoperable with all other network devices that also implement the required managed entities and thus are considered OMCI-compatible.

Optional managed entities are also identified in Tables 1 and 10 below by an “0” identifier. These optional managed entities may be useful and required by an individual network operator, but are not necessary for operational compatibility between OMCI-compatible devices.

The following abbreviations are used herein in the description of the managed entities
ADSL Asymmetrical Digital Subscriber Line
ANI Access Network Interface
ARC Alarm Reporting Configuration
ATM Asynchronous Transfer Mode
ATU-C ADSL Transceiver Unit, ONU End or Central Office End
ATU-R ADSL Transceiver Unit, Remote (Subscriber) Terminal End
BER Bit Error Rate
B-PON Broadband Passive Optical Network
DSL Digital Subscriber Line
CO Central Office
CR Conditionally Required
CRC Cyclic Redundancy Code
FEC Forward Error Correction
HEC Header Error Correction
ID Identification
LSB Least Significant Bit
MAC Media Access Control
MCM Multiple Carrier Modulation
ME Managed Entity
MIB Management Information Base
MMPDU MAC Management Protocol Data Unit
MPDU MAC Protocol Data Unit
MSB Most Significant Bit
MSDU MAC Service Data Unit
NMS Network Management System
NSCds Number of Subcarrier-Downstream
NSCus Number of Subcarrier-Upstream
O Optional
OAM Operation, Administration and Maintenance
OAMP Operation, Administration, Maintenance and Provisioning
OLT Optical Line Terminal
OMCI ONT Management and Control Interface
ONT Optical Network Terminal
ONU Optical Network Unit
PHY Physical Layer
POTS Plain Old Telephone System
PM Performance Monitoring
PMS-TC Physical Media Specific-Transmission Convergence
PSD Power Spectral Density
RFI Radio Frequency Interference
SCM Single Carrier Modulation
SNR Signal to Noise Ratio
TC Transmission Conversion
UNI User Network Interface
VDSL Very High Speed DSL
VTU-O VDSL Transceiver Unit, ONU End or Central Office End (also referred to as VTU-C)
VTU-R VDSL Transceiver Unit, Remote Terminal End

The managed entities of the present invention as set forth below define a technical specification for one embodiment of a PON OMCI (ONT management and control interface) for xDSL subscriber lines. Those skilled in the art recognize that managed entities can be added or deleted from those listed and/or managed entity attributes or elements can be modified according to the requirements or options of a different network. Thus the scope of the present invention is not limited to the technical specification as set forth below, but is intended to cover all technical specifications defined by the claims that follow.

The ADSL managed entities according to the present invention are intended for use with the various ADSL protocols known in the art, including ADSL connections operating at downstream data rates of about 1.5 Mbit/s to 6.1 Mbit/s and upstream data rates of about 16 kbit/s to 832 kbit/s for distances of about 9,000 to 18,000 feet from the service provider's central office; ADSL2 connections operating at downstream data rates of about 12 Mbit/s and upstream data rates of about 1 Mbit/s at distances of up to about 18,600 feet; ADSL2+ connections operating at downstream data rates of up to about 25 Mbit/s and upstream data rates of up to about 1 Mbit/s for distances of about 6000 to 16,000 feet from the central office. Similarly, the VDSL managed entities according to the present invention are intended for use with the various VDSL protocols known in the art, including VDSL connections operating at about 55 Mbit/s in the downstream direction and about 55 Mbit/s in the upstream direction at distances of up to about 13,000 feet.

Table 1 below lists the OMCI protocol managed entities for operation of a PON (e.g., a B-PON or a G-PON) with an ADSL network.

TABLE 1

| Managed Entity | Required/Optional | Description |
|---|---|---|
| ADSL ATU-C Channel | O | Performance monitoring data |
| Performance Monitoring History | | for an ADSL ATU-C channel |
| Data | | |
| ADSL ATU-C Performance | O | Performance monitoring data |
| Monitoring History Data | | for an ADSL ATU-C modem |
| | | path |
| ADSL ATU-R Channel | O | Performance monitoring data |
| Performance Monitoring History | | for an ADSL ATU-R channel |
| Data | | |
| ADSL ATU-R Performance | O | Performance monitoring data |
| Monitoring History Data | | for an ADSL ATU-R modem |
| | | path |
| ADSL Channel Configuration | CR | Configuration information for a |
| Profile | | channel |
| ADSL Channel Downstream | CR | Status information for the |
| Status Data | | downstream channel |
| ADSL Channel Upstream Status | CR | Status information for the |
| Data | | upstream channel |
| ADSL Downstream PSD Mask | CR | Masking information for the |
| Profile | | downstream channel PSD |
| ADSL Downstream RFI Bands | CR | Information on the downstream |
| Profile | | channel RFI bands |
| ADSL Line Configuration Profile | CR | Parameter configuration |
| Part 1 | | information for an ADSL line |
| ADSL Line Configuration Profile | CR | Parameter configuration |
| Part 2 | | information for an ADSL line |
| ADSL Line Configuration Profile | CR | Parameter configuration |
| Part 3 | | information for an ADSL line |
| ADSL Line Inventory and Status | CR | Inventory and status |
| Data Part 1 | | information for an ADSL line |
| ADSL Line Inventory and Status | CR | Inventory and status |
| Data Part 2 | | information for an ADSL line |
| ADSL Subcarrier Masking | CR | Masking information for the |
| Downstream Profile | | downstream subcarriers |
| ADSL Subcarrier Masking | CR | Masking information for the |
| Upstream Profile | | upstream subcarriers |
| Physical Path Termination Point | CR | Information for the physical |
| ADSL UNI Part 1 | | path termination point at an |
| | | ADSL CO modem |
| Physical Path Termination Point | CR | Information for the physical |
| ADSL UNI Part 2 | | path termination point at an |
| | | ADSL CO modem |
| TC Adaptor Performance | O | Performance monitoring data |
| Monitoring History Data ADSL | | for the ADSL ATM data path |

Each managed entity according to the teachings of the present invention is described below. The parenthetical entry following each managed entity indicates whether the managed entity attribute is readable (R) and/or writable (W) and whether the attribute is mandatory or optional. The number of bytes required for the attribute is also set forth.

Managed Entity: Physical Path Termination Point ADSL UNI Part 1

This managed entity represents the point at an ADSL connection in the ONU where physical paths terminate to an ADSL modem and physical path level functions (e.g., path overhead functions) are performed. One or more instances of this managed entity are automatically created/deleted by the ONU in the creation/deletion of a subscriber line card of the ADSL type, i.e., upon initialization of an ADSL subscriber line card. Upon creation, five profile pointers within the managed entity are set to their default values of 0x00. However, the physical path termination point ADSL UNI Part 1 managed entity must refer to five valid profiles before it can be operational. The five required profile values are set forth below.

Relationships

One or more instances of this managed entity are contained in an instance of a subscriber line card managed entity classified as ADSL type.

Attributes

Managed Entity ID:

This attribute provides a unique identification for each instance of the managed entity. In one embodiment, the identification comprises a 2-byte number that is directly associated with the physical position of the UNI. The first byte is the slot ID (as defined in the PON specification G.983.2). The second byte is the port ID with a value range from 0x01 to 0xFF (i.e., 1 to 255): 0x01 is used for the leftmost/lowest port on a subscriber line card, 0x02 is used for the next right/upper port, and so forth. (R) (mandatory) (2 bytes).

Loopback Configuration:

This attribute represents the loopback configuration of the physical interface. For a value 0x00 there is no loopback; a value 0x01 indicates a loopback2 (“Loopback2”), which refers to a loopback at the ONU to the OLT. The OLT can execute a physical level loopback test after loopback2 is set. Upon autonomous instantiation the default value 0x00 is set. (R, W) (mandatory) (1 byte).

Administrative State:

This attribute is used to activate (unlock value 0x00) and deactivate (lock value 0x01) the functions performed by instances of this managed entity. (R, W) (mandatory) (1 byte).

Operational State:

This attribute indicates whether or not this managed entity is capable of performing its task. The operational state reflects the perceived ability to receive or to generate a valid signal. Valid values are enabled (0x00) and disabled (0x01). (R) (optional) (1 byte).

ADSL Line Configuration Profile:

This attribute comprises the managed entity ID of the ADSL line configuration profile managed entities (parts 1, 2 and 3) (as set forth below) that contains the data necessary for initializing an ADSL modem. The value 0x00 indicates that this managed entity does not point to the ADSL line configuration profile. The value 0x00 is the default value, which is set when this managed entity is automatically created. (R, W) (mandatory) (2 bytes).

ADSL Subcarrier Masking Downstream Profile:

This attribute provides a pointer to an instance of the ADSL subcarrier masking downstream profile managed entity (described below) that contains the data necessary for initializing an ADSL modem. The value 0x00 indicates that this managed entity does not point to an ADSL subcarrier masking downstream profile. The value 0x00 is the default value, which is set when this managed entity is automatically created. (R, W) (mandatory) (2 bytes).

ADSL Subcarrier Masking Upstream Profile:

This attribute provides a pointer to an instance of the ADSL subcarrier masking upstream profile managed entity (described below) that contains the data necessary for initializing an ADSL modem. The default value 0x00 indicates that this managed entity does not point to an ADSL subcarrier masking upstream profile and is set when the managed entity is automatically created. (R, W) (mandatory) (2 bytes)

ADSL Downstream PSD Mask Profile:

This attribute provides a pointer to an instance of the ADSL downstream PSD mask profile managed entity (described below) that contains the data necessary for initializing an ADSL modem. The default value 0x00 indicates that this managed entity does not point to an ADSL downstream PSD mask profile. The default value is set when this managed entity is automatically created. (R, W) (mandatory) (2 bytes)

ADSL Downstream RFI Bands Profile:

This attribute provides a pointer to an instance of the ADSL downstream RFI bands profile managed entity that contains the data necessary for initializing an ADSL modem. The default value of 0x00 indicates that this managed entity does not point to an ADSL downstream RFI bands profile. The value 0x00 is set when this managed entity is automatically created. (R, W) (mandatory) (2 bytes)

Alarm Reporting Configuration (ARC):

This attribute controls alarm reporting from this managed entity. Valid values are “off” (alarm reporting allowed immediately) and “on” (alarm reporting inhibited). Upon initial installation and provisioning of the ONU, this attribute may be set to “on” or “off” for the time interval specified by an ARC interval attribute set forth below. If the attribute is set to “on”, alarm reporting is inhibited until this managed entity detects a valid signal for the time interval specified by “ARCInterval.” The default value is “on”. (R, W) (optional) (1 byte).

ARC Interval:

This attribute provides a provisionable length of time. Units are given in minutes. The default value is two. (R, W) (optional) (1 byte).

Actions

Get: Get one or more attributes.

Set: Set one or more attributes.

Notifications

Attribute Value Change:

This notification reports autonomous changes of attributes of this managed entity. The notification identifies the attribute and its new value. The attribute value changes for this managed entity are given in Table 2 below.

TABLE 2

| Number | AVC | Description |
|---|---|---|
| 1-2 | N/A | |
| 3 | OpState | Operational state |
| 4-10 | N/A | |
| 11-16 | Reserved | |

Alarm:

This notification notifies the network management system when a failure has been detected or cleared. In a preferred embodiment both ONU and OLT are aware of the alarm list, as set forth in Table 3 below.

TABLE 3

| | Event | |
|---|---|---|
| Number | Alarm | Description |
| 0 | NE_LOF | Near end loss of frame |
| 1 | NE_LOS | Near end loss of signal |
| 2 | NE_LOL | Near end loss of link |
| 3 | NE_LPR | Near end loss of power |
| 4 | CARD_ALM | Card in alarm |
| 5 | FE_LOF | Far end loss of frame |
| 6 | FE_LOS | Far end loss of signal |
| 7 | FE_LOL | Far end loss of link |
| 8 | FE_LPR | Far end loss of power |
| 9 | DRT_UP | Data rate threshold up-shift alarm |
| 10 | DRT_DOWN | Data rate threshold down-shift alarm |

Managed Entity: Physical Path Termination Point ADSL UNI Part 2

This managed entity represents the point at an ATM UNI in the ONU where physical paths terminate to an ADSL modem. One or more instances of this managed entity are automatically created/deleted by the ONU upon the creation/deletion of a subscriber line card of ADSL type. Upon creation of this managed entity, the eight profile pointers within the managed entity are set to their default values of 0x00. However, the managed entity must refer to at least two valid profiles before it can be operational.

Relationships

One or more instances of this managed entity are contained in an instance of a subscriber line card managed entity classified as ADSL type.

Attributes

Managed Entity ID

This attribute provides a unique number for each instance of this managed entity. This 2-byte number is directly associated with the physical position of the UNI. The first byte is the slot ID (defined in the PON specification G.983.2). The second byte is the port ID with a value range from 0x01 to 0xFF (1 to 255): 0x01 is used for the leftmost/lowest port on a subscriber line card, 0x02 is used for the next right/upper port, and so forth. (R) (mandatory) (2 bytes)

ADSL Channel Configuration Profiles (For Bearer Channels 0-4 Downstream)

Each of the four attributes (one each for downstream channels 0-4) provides a pointer to an instance of the ADSL channel configuration profile managed entity (described below) for the downstream bearer channels 0-4 that contains the data necessary for initializing the ADSL modem. The default value 0x00 is used for each attribute to indicate that this managed entity does not point to an ADSL channel configuration profile. The default value is set when this managed entity is automatically created. (R, W) (Optional) (2 bytes for each of the four bearer channel profiles)

ADSL Channel Configuration Profile (For Bearer Channels 0-4 Upstream)

Each of the four attributes (one each for upstream channels 0-4) provides a pointer to an instance of the ADSL channel configuration profile managed entity (described below) for the upstream bearer channels 0-4 that contains the data necessary for initializing an ADSL modem. The default value 0x00, which is set when the managed entity is automatically created, indicates that this managed entity does not point to an ADSL channel configuration profile. (R, W) (Optional) (2 bytes for each of the four bearer channel profiles)

Actions

Get: Get one or more attributes.

Set Set one or more attributes.

Managed Entity: ADSL Line Inventory and Status Data Part 1

This managed entity contains part 1 of the line inventory and status data for an ADSL line. One or more instances of this managed entity are automatically created/deleted by the ONU upon the creation/deletion of a subscriber line card of ADSL type.

Relationships

One or more instances of this managed entity are contained in an instance of a subscriber line card managed entity classified as ADSL type. All attributes of the managed entity, other than the managed entity identification, default to zero upon creation.

Attributes

Managed Entity ID:

This attribute provides a unique identification number for each instance of this managed entity. The assigned number is the same as the identification of the physical path termination point ADSL UNI with which this ADSL line inventory data is associated. (R) (mandatory) (2 bytes)

ATU-C G.994.1 Vendor ID:

The ATU-C G.994.1 vendor identification is the vendor identification as inserted by the ATU-C in the G.994.1 CL message. It consists of 8 binary octets, including a country code followed by a (regionally allocated) provider code, as defined in Recommendation T.35. (R) (mandatory) (8 bytes)

ATU-R G.994.1 Vendor ID:

The ATU-R G.994.1 vendor identification is the vendor identification as inserted by the ATU-R in the G.994.1 CL message. It comprises 8 binary octets in the same format as the ATU-C G.994.1 vendor identification above. (R) (mandatory) (8 bytes)

ATU-C System Vendor ID:

The ATU-C system vendor identification is the vendor identification as inserted by the ATU-C in the overhead messages. It comprises 8 binary octets in the same format as the ATU-C G.994.1 vendor identification. (R) (mandatory) (8 bytes)

ATU-R System Vendor ID:

The ATU-R system vendor ID is the vendor ID as inserted by the ATU-R in the embedded operations channel and the overhead messages. It comprises 8 binary octets, with same format as the ATU-C G.994.1 vendor ID (R) (mandatory) (8 bytes)

ATU-C Version Number:

The ATU-C version number is the version number as inserted by the ATU-C in the overhead messages. It is for version control and is vendor specific information and comprises up to 16 binary octets (R) (mandatory) (16 bytes)

ATU-R Version Number:

The ATU-R version number is the version number as inserted by the ATU-R in the embedded operations channel and overhead messages. It is for version control and is vendor specific information and comprises up to 16 binary octets. (R) (mandatory) (16 bytes)

ATU-C Serial Number Parts 1 and 2:

The ATU-C serial number is the serial number as inserted by the ATU-C in the overhead messages. It is vendor specific information and comprises up to 32 ASCII characters. Part 1 of the attribute comprises the first 16 characters and part 2 comprises the second 16 characters. (R) (mandatory) (16 bytes for each part)

ATU-R Serial Number Parts 1 and 2:

The ATU-R version number is the version number as inserted by the ATU-R in the embedded operations channel or overhead messages. It is vendor specific information comprising up to 32 ASCII characters. Part 1 comprises the first 16 characters and part 2 the next 16 characters. (R) (mandatory) (16 bytes for each part)

ATU-C Self-Test Results:

This parameter defines the ATU-C self-test result, coded as a 32-bit integer. The most significant octet of the self-test result is 00hex if the self-test passed and 01 hex if the self-test failed. The interpretation of the other octets is vendor discretionary and can be interpreted in combination with G.994.1 and system vendor IDs. (R) (mandatory) (4 bytes)

ATU-R Self-Test Results:

This parameter defines the ATU-R self-test result, coded as a 32-bit integer. The most significant octet of the self-test result is 00hex if the self-test passed and 01hex if the self-test failed. The interpretation of the other octets is vendor discretionary and can be interpreted in combination with G.994.1 and system vendor IDs. (R) (mandatory) (4 bytes)

ATU-C Transmission System Capability:

This parameter defines the ATU-C transmission system capability list of coding types. It is coded in a bit-map representation with the bits defined in Table 4 below. (R) (mandatory) (7 bytes)

ATU-R Transmission System Capability:

This parameter defines the ATU-R transmission system capability list of the different coding types. It is coded in a bit-map representation with the bits defined in Table 4 below. (R) (mandatory) (7 bytes)

Initialization-Success/Failure Cause

This parameter represents the success or failure (and failure cause) of the last full initialization performed on the line. It is coded as an integer in the 0 to 5 range, coded as follows:

0 Successful

1 Configuration error

This error occurs with inconsistencies in configuration parameters. e.g., when the line is initialized in an ADSL transmission system where an ATU does not support the configured maximum delay or the configured minimum or maximum data rate for one or more bearer channels.

2 Configuration not feasible on the line

This error occurs if the minimum data rate cannot be reached on the line with the minimum noise margin, maximum PSD level, maximum delay and maximum bit error ratio for one or more bearer channels.

3 Communication problem

This error occurs due to corrupted messages or bad syntax messages or if no common mode can be selected in the G.994.1 handshaking procedure or due to a timeout.

4 No peer ATU detected

This error occurs if the peer ATU is not powered, not connected or if the line is too long to allow detection of a peer ATU.

5 Any other or unknown initialization failure cause. (R) (mandatory) (1 byte)

Actions

Get: Get one or more attributes.

Notifications

None.

The following Table 4 is an explanation of the ATU transmission system capability attributes in the ADSL managed entity. It is coded in a bit-map representation (0 if not allowed, 1 if allowed) with following definition:

TABLE 4

| | |
|---|---|
| Bit | Representation |

Octet 1

| | |
|---|---|
| 1 | ANSI T1.413 |
| 2 | Annex C of TS 101 388 v1.3.1 |
| 3 | G.992.1 operation over POTS non-overlapped spectrum (Annex A of G.992.1) |
| 4 | G.992.1 operation over POTS overlapped spectrum (Annex A of G.992.1) |
| 5 | G.992.1 operation over ISDN non-overlapped spectrum (Annex B of G.992.1) |
| 6 | G.992.1 operation over ISDN overlapped spectrum (Annex B of G.992.1) |
| 7 | G.992.1 operation in conjunction with TCM-ISDN non-overlapped spectrum |
| | (Annex C of G.992.1) |
| 8 | G.992.1 operation in conjunction with TCM-ISDN overlapped spectrum |
| | (Annex C of G.992.1) |

Octet 2

| | |
|---|---|
| 9 | G.992.2 operation over POTS non-overlapped spectrum (Annex A of G.992.2) |
| 10 | G.992.2 operation over POTS overlapped spectrum (Annex B of G.992.2) |
| 11 | G.992.2 operation in conjunction with TCM-ISDN non-overlapped spectrum |
| | (Annex C of G.992.2) |
| 12 | G.992.2 operation in conjunction with TCM-ISDN overlapped spectrum |
| | (Annex C of G.992.2) |
| 13 | Reserved |
| 14 | Reserved |
| 15 | Reserved |
| 16 | Reserved |

Octet 3

| | |
|---|---|
| 17 | Reserved |
| 18 | Reserved |
| 19 | G.992.3 operation over POTS non-overlapped spectrum (Annex A of G.992.3) |
| 20 | G.992.3 operation over POTS overlapped spectrum (Annex A of G.992.3) |
| 21 | G.992.3 operation over ISDN non-overlapped spectrum (Annex B of G.992.3) |
| 22 | G.992.3 operation over ISDN overlapped spectrum (Annex B of G.992.3) |
| 23 | Reserved |
| 24 | Reserved |

Octet 4

| | |
|---|---|
| 25 | G.992.4 operation over POTS non-overlapped spectrum (Annex A of G.992.4). |
| 26 | G.992.4 operation over POTS overlapped spectrum (Annex A of G.992.4). |
| 27 | Reserved. |
| 28 | Reserved. |
| 29 | G.992.3 All Digital Mode operation with non-overlapped spectrum (Annex I |
| | of G.992.3). |
| 30 | G.992.3 All Digital Mode operation with overlapped spectrum (Annex I of G.992.3). |
| 31 | G.992.3 All Digital Mode operation with non-overlapped spectrum (Annex J |
| | of G.992.3). |
| 32 | G.992.3 All Digital Mode operation with overlapped spectrum (Annex J of G.992.3). |

Octet 5

| | |
|---|---|
| 33 | G.992.4 All Digital Mode operation with non-overlapped spectrum (Annex I |
| | of G.992.4). |
| 34 | G.992.4 All Digital Mode operation with overlapped spectrum (Annex I of |
| | G.992.4). |
| 35 | G.992.3 Reach Extended operation over POTS, Mode 1 (non-overlapped, |
| | wide upstream) |
| | (Annex L of G.992.3) |
| 36 | G.992.3 Reach Extended operation over POTS, Mode 2 (non-overlapped, narrow |
| | upstream) |
| | (Annex L of G.992.3) |
| 37 | G.992.3 Reach Extended operation over POTS, Mode 3 (overlapped, wide |
| | upstream) |
| | (Annex L of G.992.3) |
| 38 | G.992.3 Reach Extended operation over POTS, Mode 4 (overlapped, |
| | narrow upstream) |
| | (Annex L of G.992.3) |
| 39 | G.992.3 Extended upstream operation over POTS non-overlapped |
| | spectrum (Annex M of G.992.3) |
| 40 | G.992.3 Extended upstream operation over POTS overlapped spectrum |
| | (Annex M of G.992.3) |

Octet 6

| | |
|---|---|
| 41 | G.992.5 operation over POTS non-overlapped spectrum (Annex A of |
| | G.992.5) |
| 42 | G.992.5 operation over POTS overlapped spectrum (Annex A of G.992.5) |
| 43 | G.992.5 operation over ISDN non-overlapped spectrum (Annex B of |
| | G.992.5) |
| 44 | G.992.5 operation over ISDN overlapped spectrum (Annex B of G.992.5) |
| 45 | Reserved |
| 46 | Reserved |
| 47 | G.992.5 All Digital Mode operation with non-overlapped spectrum (Annex I |
| | of G.992.5). |
| 48 | G.992.5 All Digital Mode operation with overlapped spectrum (Annex I of |
| | G.992.5). |

Octet 7

| | |
|---|---|
| 49 | G.992.5 All Digital Mode operation with non-overlapped spectrum (Annex |
| | J of G.992.5). |
| 50 | G.992.5 All Digital Mode operation with overlapped spectrum (Annex J of |
| | G.992.5). |
| 51 | G.992.5 Extended upstream operation over POTS non-overlapped |
| | spectrum (Annex M of G.992.5) |
| 52 | G.992.5 Extended upstream operation over POTS overlapped spectrum |
| | (Annex M of G.992.5) |
| 53 | Reserved |
| 54 | Reserved |
| 55 | Reserved |
| 56 | Reserved |

Managed Entity: ADSL Line Inventory and Status Data Part 2

This managed entity contains part 2 of the line inventory and status data for an ADSL line. One or more instances of this managed entity are automatically created/deleted by the ONU upon the creation/deletion of a subscriber line card of ADSL type.

Relationships

One or more instances of this managed entity are contained in an instance of a subscriber line card managed entity classified as ADSL type.

Attributes

Managed Entity ID:

This attribute provides a unique identification for each instance of this managed entity. The assigned number is the same as the ID of the physical path termination point ADSL UNI with which this ATU-R physical data is associated. (R) (mandatory) (2 bytes)

ADSL Transmission System:

This parameter defines the transmission system in use. It is coded in bitmap representation with the bits defined in Table 4 above. (R) (mandatory) (7 bytes)

Line Power Management State:

The Line has four possible power management states, numbered 0 to 3 and corresponding to respectively:

0=L0 —Synchronized—This line state (L0) is when the line has full transmission capability (i.e. showtime).

1=L1 —Power down data transmission—This line state (L1) applies when there is transmission on the line but the net data rate is reduced (e.g. only for OAM and higher layer connection and session control). This state applies to applications governed by the G.992.2 specification only.

2=L2—Power down data transmission—This line state (L2) applies when there is transmission on the line but the net data rate is reduced (e.g. only for OAM and higher layer connection and session control). This state applies to applications governed by the G.992.3 and G.992.4 specifications only.

3=L3—No-power—This line state (L3) applies when there is no power transmitted on the line. (R) (mandatory) (1 byte)

Downstream Line Attenuation:

This parameter is the measured difference in the total power transmitted by the ATU-C and the total power received by the ATU-R over all subcarriers during diagnostics mode and initialization. The downstream line attenuation ranges from 0 (0) to +127 (1270) dB with 0.1 dB steps. A special value (0xFFFF) indicates the line attenuation is out of range and cannot be represented by the available values of the attribute. (R) (mandatory) (2 bytes)

Upstream Line Attenuation:

This parameter is the measured difference (in dB) in the total power transmitted by the ATU-R and the total power received by the ATU-C over all subcarriers during diagnostics mode and initialization. The upstream line attenuation ranges from 0 (0) to +127 (1270) dB with 0.1 dB steps. A special value (0xFFFF) indicates the line attenuation is out of range and cannot be represented by the available values of the attribute. (R) (mandatory) (2 bytes)

Downstream Signal Attenuation:

This parameter is the measured difference in dB in the total power transmitted by the ATU-C and the total power received by the ATU-R over all subcarriers during showtime, (i.e., a period when the ATU-R and ATU-C are operational). The downstream line attenuation ranges from 0 (0) to +127 (1270) dB with 0.1 dB steps. A special value (0xFFFF) indicates the line attenuation is out of range and cannot be represented by the available values of the attribute. (R) (mandatory) (2 bytes)

Upstream Signal Attenuation:

This parameter is the measured difference in dB in the total power transmitted by the ATU-R and the total power received by the ATU-C over all subcarriers during showtime. The upstream line attenuation ranges from 0 (0) to +127 (1270) dB with 0.1 dB steps. A special value (0xFFFF) indicates the line attenuation is out of range and cannot be represented by the available values of the attribute. (R) (mandatory) (2 bytes)

Downstream Signal-to-Noise Ratio Margin:

The downstream signal-to-noise ratio margin is the maximum increase in dB of the noise power received at the ATU-R, such that the BER requirements are met for all downstream bearer channels. The downstream SNR margin ranges from −64 (0) dB to +63 (1280) dB with 0.1 dB steps. A special value (0xFFFF) indicates the parameter is out of range and cannot be represented. (R) (mandatory) (2 bytes)

Upstream Signal-to-Noise Ratio Margin:

The upstream signal-to-noise ratio margin is the maximum increase in dB of the noise power received at the ATU-C, such that the BER requirements are met for all upstream bearer channels. The upstream SNR margin ranges from −64 (0) dB to +63 (1280) dB with 0.1 dB steps. A special value (0xFFFF) indicates the parameter is out of range and cannot be represented. (R) (mandatory) (2 bytes)

Downstream Maximum Attainable Data Rate:

This parameter indicates the maximum downstream net data rate currently attainable by the ATU-C transmitter and the ATU-R receiver. The rate is coded in bit/s. (R) (mandatory) (4 bytes)

Upstream Maximum Attainable Data Rate:

This parameter indicates the maximum upstream net data rate currently attainable by the ATU-R transmitter and the ATU-C receiver. The rate is coded in bit/s. (R) (mandatory) (4 bytes)

Downstream Actual Power Spectrum Density:

This parameter is the average downstream transmit power spectral density over the used subcarriers (subcarriers to which downstream user data are allocated) delivered by the ATU-C at the U-C reference point defined in ITU-T G.997.1 at the instant of measurement. The power spectral density level ranges from −90 (0) dBm/Hz to 0 (900) dBm/Hz with 0.1 dB steps. A special value (0xFFFF) indicates the parameter is out of range and cannot be represented. (R) (mandatory) (2 byte)

Upstream Actual Power Spectrum Density:

This parameter is the average upstream transmit power spectrum density over the used subcarriers (subcarriers to which upstream user data are allocated) delivered by the ATU-C at the U-C reference point at the instant of measurement. The power spectrum density level ranges from −90 (0) dBm/Hz to 0 (900) dBm/Hz with 0.1 dB steps. A special value (0xFFFF) indicates the parameter is out of range to be represented. (R) (mandatory) (2 bytes)

Downstream Actual Aggregate Transmit Power:

This parameter is the total amount of transmit power delivered by the ATU-C at the U-C reference point, at the instant of measurement. The total output power level ranges from −31 (0) dBm to +31 (620) dBm with 0.1 dB steps. A special value (0xFFFF) indicates the parameter is out of range to be represented. In one embodiment, the downstream nominal aggregate transmit power is a best estimate of this parameter. (R) (mandatory) (2 bytes)

Upstream Actual Aggregate Transmit Power:

This parameter is the total amount of transmit power delivered by the ATU-R at the U-R reference point defined in ITU-T G.997.1, at the instant of measurement. The total output power level ranges from −31 (0) dBm to +31 (620) dBm with 0.1 dB steps. A special value (0xFFFF) indicates the parameter is out of range to be represented. In one embodiment the upstream nominal aggregate transmit power may be taken as a best estimate of this parameter. (R) (mandatory) (2 bytes)

Initialization-Last State Transmitted Downstream:

This parameter represents the last successful transmitted initialization state in the downstream direction in the last full initialization performed on the line. Initialization states are defined in the individual ADSL recommendations and are counted from 0 (if G.994.1 is used) or 1 (if G.994.1 is not used) up to showtime. This parameter must be interpreted in light of the ADSL transmission system.

This parameter is available only when, after a failed full initialization, the line diagnostics procedures are activated on the line. Line diagnostics procedures can be activated by the operator of the system (through the line state forced line configuration parameter) or autonomously by the ATU-C or ATU-R. (R) (mandatory) (1 byte)

Initialization-Last State Transmitted Upstream:

This parameter represents the last successful transmitted initialization state in the upstream direction in the last full initialization performed on the line. Initialization states are defined in the individual ADSL recommendations and are counted from 0 (if G.994.1 is used) or 1 (if G.994.1 is not used) up to showtime. This parameter must be Interpreted in light of the ADSL transmission system.

This parameter is available only when, after a failed full initialization, the line diagnostics procedures are activated on the line. Line diagnostics procedures can be activated by the operator of the system (through the line state forced line configuration parameter) or autonomously by the ATU-C or ATU-R. (R) (mandatory) (1 bytes)

Actions

Get: Get one or more attributes.

Notifications

None.

Managed Entity: ADSL Channel Downstream Status Data

This managed entity contains the ADSL channel downstream status data. One or more instances of this managed entity is automatically created/deleted by the ONU upon the creation/deletion of a subscriber line card of the ADSL type.

Relationships

One or more instances of this managed entity is contained in an instance of a subscriber line card managed entity classified as ADSL type.

Attributes

Managed Entity ID:

This attribute provides a unique number for each instance of this managed entity. This 2-byte number is directly associated with the physical position of the UNI. The two most significant bits of the first byte identify the bearer channel ID. The six least significant bits of the first byte identify the slot ID (defined in G.983.2). The second byte is the port ID with a value range from 0x01 to 0xFF (1 to 255): 0x01 is used for the leftmost/lowest port on a subscriber line card, 0x02 is used for the next right/upper port, and so forth. (R) (mandatory) (2 bytes)

Actual Interleaving Delay:

This parameter is the actual one-way interleaving delay introduced by the PMS-TC between the alpha and beta reference points, excluding delay in the L1 and L2 states (as set forth above in the Line Power Management State of the ADSL Line Inventory and Status Data Part 2 Managed Entity). In the L1 and L2 states, the parameter contains the interleaving delay in the previous L0 state. This parameter is derived from the S and D parameters as ┌S*D┐/4 ms, where “S” is the symbols per codeword, “D” is the interleaving depth and ┌x┐ denotes rounding to the next higher integer. The actual interleaving delay is coded in ms rounded to the nearest ms. (R) (mandatory) (1 byte)

Actual Data Rate:

This parameter reports the actual net data rate the operating bearer channel, excluding the rate in L1 and L2 states. In L1 or L2 states, the parameter contains the net data rate in the previous L0 state. The data rate is coded in bit/s. (R) (mandatory) (4 bytes)

Previous Data Rate:

This parameter reports the previous net data rate the bearer channel was operating at just before the latest rate change event occurred, excluding all transitions between the L0 state and the L1 or L2 states. A rate change can occur at a power management state transition, e.g., at full or short initialization, fast retrain, power down or at a dynamic rate adaptation point. The rate is coded in bit/s. (R) (mandatory) (4 bytes)

Actions

Get: Get one or more attributes.

Notifications

None.

Managed Entity: ADSL Channel Upstream Status Data

This managed entity contains the ADSL channel upstream status data. One or more instances of this managed entity shall be automatically created/deleted by the ONU upon the creation/deletion of a subscriber line card of ADSL type.

Relationships

One or more instances of this managed entity shall be contained in an instance of a subscriber line card managed entity classified as ADSL type.

Attributes

Managed Entity ID:

This attribute provides a unique number for each instance of this managed entity. This 2-byte number is directly associated with the physical position of the UNI. The two most significant bits of the first byte is the bearer channel ID. The six least significant bits of the first byte is the slot ID (defined in G.983.2). The second byte is the port ID with a value range from 0x01 to 0xFF (1 to 255): 0x01 is used for the leftmost/lowest port on a subscriber line card, 0x02 is used for the next right/upper port, and so forth. (R) (mandatory) (2 bytes)

Actual Interleaving Delay:

This parameter is the actual one-way interleaving delay introduced by the PMS-TC between the alpha and beta reference points, excluding delay in L1 and L2 states. In L1 and L2 state, the parameter contains the interleaving delay in the previous L0 state. This parameter is derived from the S and D parameters as ┌S*D┐/4 ms, where “S” is the symbols per codeword, “D” is the “interleaving depth” and ┌x┐ denotes rounding to the higher integer. The actual interleaving delay is coded in ms (rounded to the nearest ms). (R) (mandatory) (1 byte)

Actual Data Rate:

This parameter reports the actual net data rate the bearer channel is operating at, excluding the rate in L1 and L2 states. In L1 or L2 states, the parameter contains the net data rate in the previous L0 state. The data rate is coded in bit/s. (R) (mandatory) (4 bytes)

Previous Data Rate:

This parameter reports the previous net data rate at which the bearer channel was operating before the latest rate change event occurred, excluding all transitions between the L0 state and L1 or L2 states. A rate change can occur at a power management state transition, e.g., at a full or a short initialization, a fast retrain, a power down or a dynamic rate adaptation. The rate is coded in bit/s. (R) (mandatory) (4 bytes)

Actions

Get: Get one or more attributes.

Notifications

None.

Managed Entity: ADSL Line Configuration Profile Part 1

This managed entity contains part 1 of the line configuration profile for an ADSL line. An instance of this managed entity is created/deleted on request of the OLT.

Relationships

Zero or more instances of this managed entity exist and may be associated with zero or more instances of the physical path termination point ADSL UNI.

Attributes

Managed Entity ID:

This attribute provides a unique number for each instance of this managed entity. The value 0x00 is reserved. (R, Set-by-create) (mandatory) (2 bytes)

ATU Transmission System Enabling:

This configuration parameter defines the transmission system coding types to be allowed by the near-end ATU (i.e., the ATU-C) on this line. This parameter only applies to the Q-interface reference. It is coded in a bit-map representation with the bits defined in Table 4 above. (R, W, Set-by-create) (mandatory) (7 bytes)

Power Management State Forced:

This configuration parameter defines the line states to be forced by the near-end ATU on this line. It is coded as an integer value with following definition:

0 Force the line to transition from the L3 idle state to the L0 full-on state. This transition requires the (short) initialization procedure. After reaching the L0 state, the line may transition into or exit from the L2 low power state (if L2 state is enabled). If the L0 state is not reached (after a vendor discretionary number of retries and/or within a vendor discretionary timeout), then an initialization failure occurs. Whenever the line is in the L3 state, attempts are made to transition to the L0 state until it is forced into another state through this configuration parameter.

2 Force the line to transition from L0 full on to L2 low power state. This transition requires entry into L2 mode. This is an out-of-service test value for triggering the L2 mode.

3 Force the line to transition from the L0 full on or L2 low power state to the L3 idle state. This transition requires the (orderly) shutdown procedure. After reaching the L3 state, the line remains in the L3 idle state until it is forced into another state through this configuration parameter. (R, W, Set-by-create) (mandatory) (1 byte)

Power Management State Enabling:

This configuration parameter defines the line states the ATU-C or ATU-R may autonomously transition to on this line. It is coded in a bit-map representation (0 if not allowed, 1 if allowed) with following definition:

Bit 0: L3 state (Idle state)

Bit 1: L1/L2 state (Low power state)

(R, W, Set-by-create) (mandatory) (1 byte)

Downstream Target Noise Margin:

This is the noise margin the ATU-R receiver should achieve, relative to the BER requirement for each of the downstream bearer channels, or better, to successfully complete initialization. The target noise margin ranges from 0 (0) to 31 (310) dB with 0.1 dB steps. (R, W, Set-by-create) (mandatory) (2 bytes)

Upstream Target Noise Margin:

This is the noise margin the ATU-C receiver should achieve, relative to the BER requirement for each of the upstream bearer channels, or better, to successfully complete initialization. The target noise margin ranges from 0 (0) to 31 (310) dB at 0.1 dB steps. (R, W, Set-by-create) (mandatory) (2 bytes)

Downstream Maximum Noise Margin:

This is the maximum noise margin the ATU-R receiver attempts to sustain. If the noise margin is above this level, the ATU-R requests the ATU-C to reduce the ATU-C transmit power to attain a noise margin below this limit (if this functionality is supported). The maximum noise margin ranges from 0 (0) to 31 (310) dB with 0.1 dB steps. A special value of 0xFFFF is used to indicate that no maximum noise margin limit is to be applied. (R, W, Set-by-create) (mandatory) (2 bytes)

Upstream Maximum Noise Margin:

This is the maximum noise margin the ATU-C receiver attempts to sustain. If the noise margin is above this level, the ATU-C requests the ATU-R to reduce the ATU-R transmit power to attain a noise margin that is below this limit (if this functionality is supported). The maximum noise margin ranges from 0 (0) to 31 (310) dB with 0.1 dB steps. A special value of 0xFFFF is used to indicate that no maximum noise margin limit is to be applied. (R, W, Set-by-create) (mandatory) (2 bytes)

Downstream Minimum Noise Margin:

This is the minimum noise margin the ATU-R receiver can tolerate. If the noise margin falls below this level, the ATU-R requests the ATU-C to increase the ATU-C transmit power. If an increase in ATU-C transmit power is not possible, a loss-of-margin (LOM) defect occurs, the ATU-R fails and attempts to re-initialize and the NMS/EMS 70 is notified. The minimum noise margin ranges from 0 (0) to 31 (310) dB with 0.1 dB steps. (R, W, Set-by-create) (mandatory) (2 bytes)

Upstream Minimum Noise Margin:

This is the minimum noise margin the ATU-C receiver shall tolerate. If the noise margin falls below this level, the ATU-C requests the ATU-R to increase the ATU-R transmit power. If a power increase is not possible, a loss-of-margin (LOM) defect occurs, the ATU-C fails and attempts to re-initialize and the NMS/EMS 70 is notified. The minimum noise margin ranges from 0 (0) to 31 (310) dB with 0.1 dB steps (R, W, Set-by-create) (mandatory) (2 bytes)

Downstream Rate Adaptation Mode:

This parameter specifies the mode of operation of a rate-adaptive ATU-C in the transmit direction. The parameter can take three values.

1=Mode 1: Manual—Rate changed manually.

At start-up:

The downstream minimum data rate parameter specifies the data rate the ATU-C transmitter operates at for each of the bearer channels, with a downstream noise margin which is at least as large as the specified downstream target noise margin, relative to the required BER for each of the downstream bearer channels, or better. If the ATU-C fails to achieve the downstream minimum data rate for one of the bearer channels, the ATU-C fails to initialize, and the NMS/EMS 70 is notified. Although the ATU-C and the line might be able to support a higher data rate, the ATU-C does not transmit at a data rate higher than what is requested for each of the bearer channels.

At showtime:

The ATU-C transmitter maintains the specified downstream minimum data rate for each of the bearer channels.

2=Mode 2: AT_INIT—The rate is automatically selected at start-up only and does not change after that.

At start-up:

The downstream minimum rate parameter specifies the minimum data rate the ATU-C transmitter operates at for each of the bearer channels, with a downstream noise margin, which is at least as large as the specified downstream target noise margin, relative to the required BER for each of the bearer channels, or better. If the ATU-C fails to achieve the downstream minimum data rate for one of the bearer channels, the ATU-C fails to initialize and the NMS is notified. If the ATU-C transmitter is able to support a higher downstream data rate at initialization, the excess data rate is distributed among the downstream bearer channels according to the ratio (0 to 100%) specified by the rate adaptation ratio parameter for each bearer channel (adding up to 100% over all bearer channels). When the downstream maximum data rate is achieved in one of the bearer channels, then the remaining excess bit rate is assigned to the other bearer channels, still according to their relative rate adaptation ratio parameters. As long as the downstream data rate is below the downstream maximum data rate for one of the bearer channels, data rate increases take priority over transmit power reduction.

At showtime:

During showtime, no downstream data rate adaptation is allowed. The downstream data rate, which has been settled during initialization for each of the bearer channels, is maintained.

3=Mode 3: Dynamic—Data rate is automatically selected at initialization and is continuously adapted during operation (showtime). The dynamic rate adaptation mode is optional. All related configuration parameters are also optional.

At start-up: In mode 3, the ATU-C starts up as in mode 2.

At showtime:

During showtime, rate adaptation is allowed with respect to the adaptation ratio for distributing the excess data rate among the bearer channels (see Mode 2 above), and assuring that the downstream minimum data rate remains available at the required BER for each of the bearer channels, or better. The downstream data rate can vary between the downstream minimum data rate and the downstream maximum data rate. Downstream rate adaptation is performed when the conditions specified for downstream up shift noise margin and downstream up shift interval (or for downstream downshift noise margin and downstream downshift interval) are satisfied. This means:
For an up shift action: Allowed when the downstream noise margin is above the downstream up shift noise margin during downstream minimum time interval for up shift rate adaptation (i.e. upon RAU anomaly).
For a downshift action: Allowed when the downstream noise margin is below the downstream downshift noise margin during downstream minimum time interval for downshift rate adaptation (i.e. upon RAD anomaly).

As long as the downstream data rate is below the downstream maximum data rate for one of the bearer channels, data rate increases take priority over transmit power reduction. (R, W. Set-by-create) (mandatory) (1 byte)

Upstream Rate Adaptation Mode:

This parameter specifies the mode of operation of a rate-adaptive ATU-R in the transmit direction. The parameter is used only if the rate-adaptive functionality is supported and can take three values:

1=Manual

2=AT_INIT

3=Dynamic

The definition of each of the values is identical to their definition in the downstream rate adaptation mode as set forth above, replacing ATU-C with ATU-R and replacing downstream with upstream. (R, W, Set-by-create) (mandatory) (1 byte)

Downstream Up-Shift Noise Margin:

If the downstream noise margin is above the downstream up shift noise margin and stays above that for more than the time specified by the downstream minimum up shift rate adaptation interval, the ATU-R increases the downstream net data rate. The downstream up shift noise margin ranges from 0 dB (0) to 31 (310) dB with 0.1 dB steps. (R, W, Set-by-create) (optional) (2 bytes)

Upstream Up-Shift Noise Margin:

If the upstream noise margin is above the upstream up shift noise margin and stays above that for more than the time specified by the upstream minimum up shift rate adaptation interval, the ATU-C increases the upstream net data rate. The upstream up shift noise margin ranges from 0 dB (0) to 31 (310) dB with 0.1 dB steps. (R, W, Set-by-create) (optional) (2 bytes)

Upstream PSD Mask Selection:

This configuration parameter defines which upstream PSD mask is enabled. This parameter is used only for annexes J and M of G.992.315. As only one selection parameter is defined in the MIB, the same selection value applies to all relevant modes enabled in the ATSE line configuration parameter. It ranges from 1 to 9 and selects the mask with the following definition.

| Upstream PSD | Selected mask | |
|---|---|---|
| mask selection value | Annex J of G.992.3/5 | Annex M of G.992.3/5 |
| 1 | ADLU-32 | EU-32 |
| 2 | ADLU-36 | EU-36 |
| 3 | ADLU-40 | EU-40 |
| 4 | ADLU-44 | EU-44 |
| 5 | ADLU-48 | EU-48 |
| 6 | ADLU-52 | EU-52 |
| 7 | ADLU-56 | EU-56 |
| 8 | ADLU-60 | EU-60 |
| 9 | ADLU-64 | EU-64 |

(R, W, Set-by-create) (mandatory) (1 byte)
Minimum Overhead Rate Upstream:

This attribute defines the minimum rate of the message-based overhead that is maintained by the ATU in upstream direction. The attribute is expressed in bits per second and ranges from 4000 to 64000 bps. This attribute is valid only for systems operating in accordance with specifications G.992.3, G.992.4 and G.992.5. (R, W, Set-by-create) (optional) (2 bytes)

Minimum Overhead Rate Downstream:

This attribute defines the minimum rate of the message-based overhead that is maintained by the ATU in downstream direction. The attribute is expressed in bits per second and ranges from 4000 to 64000 bps. This attribute is valid only for systems operating in accordance with specifications G.992.3, G.992.4 and G.992.5. (R, W, Set-by-create) (optional) (2 bytes)

Actions

Create: Create an instance of this managed entity.

Delete: Delete an instance of this managed entity.

Get: Get one or more attributes.

Set: Set one or more attributes;

Notifications

None.

Managed Entity: ADSL Line Configuration Profile Part 2

This managed entity contains part 2 of the line configuration profile for an ADSL line. An instance of this managed entity is created/deleted on request of the OLT.

Relationships

Zero or more instances of this managed entity shall exist and may be associated with zero or more instances of the physical path termination point ADSL UNI.

Attributes

Managed Entity ID:

This attribute provides a unique number for each instance of this managed entity. The value 0x00 is reserved. (R, Set-by-create) (mandatory) (2 bytes)

Downstream Minimum Time Interval for Up-Shift Rate Adaptation:

This parameter defines the interval of time the downstream noise margin should stay above the downstream up-shift noise margin before the ATU-R attempts to increase the downstream net data rate. The time interval ranges from 0 to 16383 s. (R, W, Set-by-create) (optional) (2 bytes)

Upstream Minimum Time Interval for Up-Shift Rate Adaptation:

This parameter defines the interval of time the upstream noise margin should stay above the upstream up-shift noise margin before the ATU-C attempts to increase the upstream net data rate. The time interval ranges from 0 to 16383s. (R, W, Set-by-create) (optional) (2 bytes)

Downstream Down-Shift Noise Margin:

If the downstream noise margin is below the downstream down-shift noise margin and stays below that value for more than the time specified by the downstream minimum downshift rate adaptation interval, the ATU-R attempts to decrease the downstream net data rate. The downstream down-shift noise margin ranges from 0 (0) to 31 (310) dB with 0.1 dB steps. (R, W, Set-by-create) (optional) (2 bytes)

Upstream Down-Shift Noise Margin:

If the upstream noise margin is below the upstream down-shift noise margin and stays below that for more than the time specified by the upstream minimum downshift rate adaptation interval, the ATU-C attempts to decrease the upstream net data rate. The upstream down-shift noise margin ranges from 0 (0) to 31 (310) dB with 0.1 dB steps. (R, W, Set-by-create) (optional) (2 bytes)

Downstream Minimum Time Interval for Downshift Rate Adaptation:

This parameter defines the interval of time the downstream noise margin should stay below the downstream down-shift noise margin before the ATU-R attempts to decrease the downstream net data rate. The time interval ranges from 0 to 16383 s. (R, W, Set-by-create) (optional) (2 bytes)

Upstream Minimum Time Interval for Downshift Rate Adaptation:

This parameter defines the interval of time the upstream noise margin should stay below the upstream downshift noise margin before the ATU-C attempts to decrease the upstream net data rate. The time interval ranges from 0 to 16383 s. (R. W, Set-by-create) (optional) (2 bytes)

ATU Impedance State Forced:

This configuration parameter defines the impedance state to be forced on the near-end ATU. It applies only to the T/S-interface. It is only valid for G.992.3 (Annex A), G.992.4 (Annex A) and G.992.5 (Annex A). The parameter is coded as an integer value with following definition:

1 Force the near-end ATU to the disabled state.

2 Force the near-end ATU to the inactive state.

3 Force the near-end ATU to the active state.

(R, W, Set-by-create) (mandatory) (1 byte)

L0-TIME:

This parameter represents the minimum time (in seconds) between an exit from the L2 state and the next entry into the L2 state. It is valid only for G.992.3, G.992.4 and G.992.5. It ranges from 0 to 255 s. (R, W, Set-by-create) (mandatory) (1 byte)

L2-TIME:

This parameter represents the minimum time (in seconds) between an entry into the L2 state and the first power trim in the L2 state and also between two consecutive power trims in the L2 State. It is valid only for G.992.3, G.992.4 and G.992.5. The parameter ranges from 0 to 255 s. (R, W, Set-by-create) (mandatory) (1 byte)

Downstream Maximum Nominal Power Spectral Density:

This parameter represents the maximum nominal transmit PSD in the downstream direction during initialization and showtime (in dBm/Hz). A single downstream maximum nominal power spectral density parameter is defined per mode enabled in the ATSE line configuration parameter. It is valid only for G.992.3, G.992.4 and G.992.5 and ranges from −60 (0) to −30 (900) dBm/Hz, with 0.1 dB steps. (R, W, Set-by-create) (mandatory) (2 byte)

Upstream Maximum Nominal Power Spectral Density:

This parameter represents the maximum nominal transmit PSD in the upstream direction during initialization and showtime (in dBm/Hz). A single upstream maximum nominal power spectral density parameter is defined per mode enabled in the ATSE line configuration parameter. It is only valid for G.992.3, G.992.4 and G.992.5. It ranges from −60 (0) to −30 (900) dBm/Hz, with 0.1 dB steps. (R, W, Set-by-create) (mandatory) (2 byte)

Downstream Maximum Nominal Aggregate Transmit Power:

This parameter represents the maximum nominal aggregate transmit power in the downstream direction during initialization and showtime (in dBm). It is valid only for G.992.3, G.992.4 and G.992.5 and ranges from 0 (0) to 25.5 (255) dBm, with 0.1 dB steps. (R, W, Set-by-create) (mandatory) (1 byte)

Upstream Maximum Nominal Aggregate Transmit Power:

This parameter represents the maximum nominal aggregate transmit power in the upstream direction during initialization and showtime (in dBm). It is valid only for G.992.3, G.992.4 and G.992.5 and ranges from 0 (0) to 25.5 (255) dBm, with 0.1 dB steps. (R, W, Set-by-create) (mandatory) (1 byte)

Upstream Maximum Aggregate Receive Power:

This parameter represents the maximum upstream aggregate receive power over a set of subcarriers (in dBm) as specified in the relevant recommendation. The ATU-C requests an upstream power cutback such that the upstream aggregate receive power over that set of subcarriers is at or below the configured maximum value. It is valid only for G.992.3, G.992.4 and G.992.5. The parameter ranges from −25.5 (0) to 25.5 (510) dBm, with 0.1 dB steps. A special value of 0xFFFF is used to indicate that no upstream maximum aggregate receive power limit is to be applied. (R, W Set-by-create) (mandatory) (2 bytes)

Actions

Create: Create an instance of this managed entity.

Delete: Delete an instance of this managed entity.

Get: Get one or more attributes.

Set: Set one or more attributes.

Notifications

None.

Managed Entity: ADSL Line Configuration Profile Part 3

This managed entity comprises part 3 of the line configuration profile for an ADSL line. An instance of this managed entity is created/deleted on request of the OLT.

Relationships

Zero or more instances of this managed entity exist and may be associated with zero or more instances of the physical path termination point ADSL UNI.

Attributes

Managed Entity ID:

This attribute provides a unique number for each instance of this managed entity. The value 0x00 is reserved. (R, Set-by-create) (mandatory) (2 bytes)

Loop Diagnostics Mode Forced:

This configuration parameter defines whether the line should be forced into the loop diagnostics mode by the near-end ATU on this line. It is valid only for G.992.3, G.992.4 and G.992.5. The attribute is coded as an integer value with following definition:

0 inhibits the near-end ATU from performing loop diagnostics mode procedures on the line. Loop diagnostic mode procedures may still be initiated by the far-end ATU, i.e., the ATU-R.

1 Forces the near-end ATU to perform the loop diagnostics procedures.

The line needs to be forced to the L3 state before it can be forced to the loop diagnostics mode. Only while the line power management state is in the L3 state, can the line be forced into the loop diagnostics mode procedures. When the loop diagnostics mode procedures are completed successfully, the access node resets the loop diagnostic mode forced MIB element to 0 and the line returns to remain in the L3 idle state. The loop diagnostics data is available at least until the line is forced to the L0 state. If the loop diagnostics procedures cannot be completed successfully (after a vendor discretionary number of retries and/or within a vendor discretionary timeout), then an initialization failure occurs. As long as loop diagnostics procedures are not completed successfully, attempts are made to do so, until the loop diagnostics mode is no longer forced on the line through this configuration parameter. (R, W, Set-by-create) (mandatory) (1 byte)

Automode Cold Start Forced:

This parameter is defined to improve performance testing of ATU's supporting automode when it is enabled in the MIB. The valid values are 0 and 1. A change in value of this parameter indicates a change in loop conditions applied to the devices under test. The ATUs reset any historical information used for automode and for shortening G.994.1 handshake and initialization.

Automode is defined as the case where multiple operation-modes are enabled in the MIB in the G.997.1 “ATU Transmission System Enabling (ATSE)” table and where the selection of the operation-mode to be used for transmission does not only depend on the common capabilities of both ATUs (as exchanged in G.994.1), but depends also on achievable data rates under given loop conditions. (R, W, Set-by-create) (mandatory) (1 byte)

L2-ATPR:

This parameter represents the maximum aggregate transmit power reduction (in dB) that can be performed in the L2 Request (i.e. at transition of L0 to L2 state) or through a single power trim in the L2 state. It is valid only for G.992.3, G.992.4 and G.992.5 and ranges from 0 (0) dB to 31 (31) dB (R, W, Set-by-create) (mandatory) (1 byte)

L2-ATPRT:

This parameter represents the total maximum aggregate transmit power reduction (in dB) that can be performed in an L2 state, Including the sum of all reductions of L2 request (i.e., at transition of L0 to L2 state) and power trims. It ranges from 0 (0) dB to 31 (31) dB. (R, W, Set-by-create) (mandatory) (1 byte)

Actions

Create: Create an instance of this managed entity.

Delete: Delete an instance of this managed entity.

Get: Get one or more attributes.

Set: Set one or more attributes.

Notifications

None.

Managed Entity: ADSL Channel Configuration Profile

This managed entity contains the channel configuration profile for an ADSL line. An instance of this managed entity is created/deleted on request of the OLT.

Relationships

Zero or more instances of this managed entity shall exist and may be associated with zero or more instances of the physical path termination point ADSL UNI.

Attributes

Managed Entity ID:

This attribute provides a unique number for each instance of this managed entity. The value 0x00 is reserved. (R, Set-by-create) (mandatory) (2 bytes)

Minimum Data Rate:

This parameter specifies the minimum net data rate for the bearer channel as desired by the operator of the system. The rate is coded in bit/s. (R, Set-by-create) (mandatory) (4 bytes)

Maximum Data Rate:

This parameter specifies the maximum net data rate for the bearer channel as desired by the operator of the system. The data rate is coded in bit/s. (R, Set-by-create) (mandatory) (4 bytes)

Rate Adaptation Ratio:

This parameter (expressed in percent) specifies the ratio that should be taken into account for the bearer channel when performing rate adaptation in the direction of the bearer channel. The ratio is defined as a percentage in the 0 to 100 range. A ratio of 20% means that 20% of the available data rate (in excess of the minimum data rate summed over all bearer channels) will be assigned to this bearer channel and 80% to the other bearer channels. The sum of rate adaptation ratios over all bearer channels in one direction equals 100%. (R, Set-by-create) (optional) (1 byte)

Maximum Interleaving Delay:

This parameter is the maximum one-way interleaving delay introduced by the PMS-TC between the alpha and the beta reference points, in the direction of the bearer channel. The one-way interleaving delay is defined in individual ADSL recommendations as ┌S*D┐/4 ms, where “S” is the S-factor, “D” is the interleaving depth and ┌x┐ denotes rounding to the higher integer.

The ATUs choose the S and D values such that the actual one-way interleaving delay is less than or equal to the configured maximum interleaving delay. The delay is coded in ms, with the value 0 and 1 special values. The value 0 indicates no delay bound is being imposed. The value 1 indicates the fast latency path is used in the G.992.1 operating mode and S and D are selected such that S≦1 and D=1 in G.992.2, G.992.3 and G.992.4 operating modes. Value range: 2-255. (R, Set-by-create) (mandatory) (1 bytes)

Data Rate Threshold Up-Shift:

This parameter is a threshold on the net data rate up-shift achieved over one or more bearer channel data rate adaptations. An up-shift rate change alarm (event) is triggered when the actual data rate exceeds the data rate at the last entry into showtime by more than the threshold. The data rate threshold is coded in bit/s. (R, Set-by-create) (mandatory) (4 bytes)

Data Rate Threshold Down-Shift:

This parameter is a threshold on the net data rate down-shift achieved over one or more bearer channel data rate adaptations. A down-shift rate change alarm (event) is triggered when the actual data rate is below the data rate at the last entry into showtime by more than the threshold. The data rate threshold is coded in bit/s. (R, Set-by-create) (mandatory) (4 bytes)

Minimum Reserved Data Rate:

This parameter specifies the minimum reserved net data rate for the bearer channel as desired by the operator of the system. The rate is coded in bit/s. (R, Set-by-create) (mandatory) (4 bytes)

Minimum Data Rate in Low Power State:

This parameter specifies the minimum net data rate for the bearer channel as desired by the operator of the system during the low power state (L1/L2). The power management low power states L1 and L2 are defined in G.992.2 and G.992.3 respectively. The data rate is coded in bit/s. (R, Set-by-create) (mandatory) (4 byte)

Minimum Impulse Noise Protection:

This parameter specifies the minimum impulse noise protection for the bearer channel. It is valid only for G.992.3, G.992.4 and G.992.5. The impulse noise protection is expressed in symbols and can take the following integer values:

1=0 symbols

2=½symbols

3=1 symbols

4=2 symbols

(R, Set-by-create) (mandatory) (1 byte)

Maximum Bit Error Ratio:

This parameter specifies the maximum bit error ratio for the bearer channel as desired by the operator of the system. It is only valid for G.992.3, G.992.4 and G.992.5. The bit error ratio can take the following integer values:

1=1E-3

2=1E-5

3=1E-7

(R, Set-by-create) (mandatory) (1 byte)

Actions

Create: Create an instance of this managed entity.

Delete: Delete an instance of this managed entity.

Get: Get one or more attributes.

Set: Set one or more attributes.

Notifications

None.

Managed Entity: ADSL Subcarrier Masking Downstream Profile

This managed entity contains the subcarrier masking downstream profile for an ADSL line. An instance of this managed entity is created/deleted on request of the OLT.

Relationships

Zero or more instances of this managed entity exist and may be associated with zero or more instances of the physical path termination point ADSL UNI.

Attributes

Managed Entity ID:

This attribute provides a unique number for each instance of this managed entity. The value 0x00 is reserved. (R, Set-by-create) (mandatory) (2 bytes)

Downstream Subcarrier Mask 1:

This configuration parameter is a bitmap representing the downstream mask values for subcarriers 1 to 128. The MSB of the first byte corresponds to subcarrier 1, and the LSB of the last byte corresponds to subcarrier 128. Each bit position defines whether the corresponding subcarrier is masked on this line in the downstream direction. It is coded as 1 if masked and 0 if not masked (default).

Subcarrier number 1 is the lowest, and subcarrier number NSCds is the highest subcarrier that can be transmitted in the downstream direction. For embodiments related to specifications G.992.3 and G.992.4, the number of downstream subcarriers (NSCds) is defined in the corresponding recommendations. For G.992.1, NSCds=256, for G.992.2, NSCds=128, and for G.992.5, NSCds=512. (R, W, Set-by-create) (mandatory) (16 bytes)

Downstream Subcarrier Mask 2:

This configuration parameter is a bitmap representing the downstream mask values for subcarriers 129 to 256. The MSB of the first byte corresponds to subcarrier 129, and the LSB of the last byte corresponds to entry 256. Each bit position defines whether the corresponding subcarrier is masked on this line in the downstream direction. It is coded as 1 if masked and 0 if not masked (default).

Subcarrier number 1 is the lowest, and subcarrier number NSCds is the highest subcarrier that can be transmitted in the downstream direction. For embodiments related to specifications G.992.3 and G.992.4, the number of subcarrier downstream (NSCds) is defined in the corresponding recommendations. For G.992.1, NSCds=256, for G.992.2, NSCds=128, and for G.992.5, NSCds=512. (R, W) (mandatory for modems that support NSCds greater then 128) (16 bytes)

Downstream Subcarrier Mask 3:

This configuration parameter is a bitmap representing the downstream mask values for subcarriers 257 to 384. The MSB of the first byte corresponds to subcarrier 257, and the LSB of the last byte corresponds to entry subcarrier 384. Each bit position defines whether the corresponding subcarrier is masked on this line in the downstream direction. It is coded as 1 if masked and 0 if not masked (default).

Subcarrier number 1 is the lowest, and subcarrier number NSCds is the highest subcarrier that can be transmitted in the downstream direction. For embodiment related to G.992.3 and G.992.4, the number of subcarrier downstream (NSCds) is defined in the corresponding recommendations. For G.992.1, NSCds=256, for G.992.2, NSCds=128, and for G.992.5, NSCds=512. (R, W) (mandatory for modems that support NSCds>256) (16 bytes)

Downstream Subcarrier Mask 4

This configuration parameter is a bitmap representing the downstream mask values for subcarriers 385 to 512. The MSB of the first byte corresponds to subcarrier 385, and the LSB of the last byte corresponds to entry subcarrier 512. Each bit position defines whether the corresponding subcarrier is masked on this line in the downstream direction. It is coded as 1 if masked and 0 if not masked (default).

Subcarrier number 1 is the lowest, and subcarrier number NSCds is the highest subcarrier that can be transmitted in the downstream direction. For embodiments related to specification G.992.3 and G.992.4, the number of subcarrier downstream (NSCds) is defined in the corresponding recommendations. For G.992.1, NSCds=256, for G.992.2, NSCds=128, and for G.992.5, NSCds=512. (R, W) (mandatory for modems that support NSCds>384) (16 bytes)

TableValid:

This Boolean attribute controls and reports the operational status of this downstream subcarrier mask attributes. If this attribute is true (coded as 0x01), then the downstream subcarrier mask represented in this managed entity has been impressed on the DSL equipment. If this attribute is false (coded as 0x00), then the downstream subcarrier mask represented in this managed entity has not been impressed on the DSL equipment. The default value is false. The value of this attribute can be modified by the ONU and OLT, as follows. If the OLT changes any of the four mask attributes or sets TableValid to false, then TableValid is set to false. If the TableValid is false and OLT sets TableValid to true, then the ONU will impress the downstream subcarrier mask data to the DSL equipment. (R, W) (mandatory) (1 byte)

Actions

Get: Get one or more attributes.

Set: Set one or more attributes. Note that setting the mask attributes does not directly change the DSL equipment-operating mode, because of the TableValid attribute.

Notifications

None.

Managed Entity: ADSL Subcarrier Masking Upstream Profile

This managed entity contains the subcarrier masking upstream profile for an ADSL line. An instance of this managed entity is created/deleted on request of the OLT.

Relationships

Zero or more instances of this managed entity shall exist and may be associated with zero or more instances of the physical path termination point ADSL UNI.

Attributes

Managed Entity ID:

This attribute provides a unique number for each instance of this managed entity. The value 0x00 is reserved. (R, Set-by-create) (mandatory) (2 bytes)

Upstream Subcarrier Mask:

This configuration parameter is a bitmap representing the upstream mask values for subcarriers 1 to 64. The MSB of the first byte corresponds to subcarrier 1, and the LSB of the last byte corresponds to subcarrier 64. Each bit position defines whether the corresponding subcarrier is masked on this line in the upstream direction. It is coded as 1 if masked and 0 if not masked (default).

Subcarrier number 1 is the lowest, and subcarrier number NSCus is the highest subcarrier that can be transmitted in the upstream direction. For embodiments related to specifications G.992.3 and G.992.4, the number of subcarrier upstream (NSCus) is defined in the corresponding recommendations. For G.992.1 Annex A and G.992.2, NSCus=32, for G.992.1 Annex B, NSCus=64, and for G.992.5, NSCus=64. (R, W. Set-by-create) (mandatory) (8 bytes)

Actions

Get: Get one or more attributes.

Set: Set one or more attributes. Note that in this case, setting this attribute will result in the mask information being impressed on the DSL equipment immediately.

Notifications

None.

Managed Entity: ADSL Downstream PSD Mask Profile

This managed entity contains the downstream PSD mask profile for an ADSL line. An instance of this managed entity is created/deleted on request of the OLT.

Relationships

Zero or more instances of this managed entity shall exist and may be associated with zero or more instances of the physical path termination point ADSL UNI.

Attributes

Managed Entity ID:

This attribute provides a unique number for each instance of this managed entity. The value 0x00 is reserved. (R, Set-by-create) (mandatory) (2 bytes)

Downstream PSD Mask:

This configuration parameter is a table where each entry consists of an entry number (1 byte, first entry numbered 1) field, subcarrier index (2 bytes) field, and a MIB PSD mask level (1 byte) field. This table defines the downstream PSD mask applicable at the U-C2 reference point. This MIB PSD mask may impose PSD restrictions in addition to the limit PSD mask defined in the relevant Recommendation (e.g., G.992.5).

The downstream PSD mask in the CO-MIB is specified through a set of breakpoints. Each breakpoint consists of a subcarrier index i (using the same definition of ‘i’ as given in section 8.1.10) and a MIB PSD mask level (expressed in dBm/Hz) at that subcarrier. The set of breakpoints can then be represented as [(i1, PSD-1), (i2, PSD-2), . . . , (iN, PSD-N)]. The MIB PSD mask level field shall be coded as an unsigned integer representing the MIB PSD mask levels 0 (0) dBm/Hz to −95 (190) dBm/Hz, in steps of 0.5 dBm/Hz. The maximum number of breakpoints is 32. This attribute is valid only for G.992.5.

The requirements for a valid set of breakpoints are defined in the relevant Recommendations (e.g., G.992.5). The entries have a default value of 0x00 for the subcarrier index and 0x0 for the MIB PSD mask level (i.e., no breakpoints). Table entries for this attribute are added or modified using the set action. Setting an entry with a non-zero subcarrier index and MIB PSD mask level implies insertion into the table. Setting an entry's subcarrier index and MIB PSD Mask Level to 0 implies deletion from the table, if present. (R, W) (mandatory) (N*4 bytes where N is the number of breakpoints)

TableValid:

This Boolean attribute controls and reports the operational status of this downstream PSD mask attribute. If this attribute is true (coded as 0x01), then the downstream PSD mask represented in this managed entity has been impressed on the DSL equipment. If this attribute is false (coded as 0x00), then the downstream PSD mask represented in this managed entity has not been impressed on the DSL equipment. The default value is false. The value of this attribute can be modified by the ONU and OLT, as follows. If the OLT changes any of the PSD mask table entries or sets TableValid to false, then TableValid is set to false. If the TableValid is false and OLT sets TableValid to true, then the ONU will impress the downstream PSD mask data to the DSL equipment. (R, W) (mandatory) (1 byte)

Actions

Get: Get one or more attributes. Latch a snapshot (i.e. copy) of the current downstream PSD mask and use four bytes to respond with the size of data which should be obtained using the “Get next” command.

Get next: Get the latched attribute values of the managed entity within the current snapshot.

Set: Generally, this action is used to set one or more entire attribute values. When used on the downstream PSD mask attribute, the set action either adds, modifies, or deletes table entries in downstream PSD mask. A maximum of 7 table entries can be added/modified/deleted by a single set action.

Notifications

None.

Managed Entity: ADSL Downstream RFI Bands Profile

This managed entity contains the downstream RFI bands profile for an ADSL line. An instance of this managed entity is created/deleted on request of the OLT.

Relationships

Zero or more instances of this managed entity shall exist and may be associated with zero or more instances of the physical path termination point ADSL UNI.

Attributes

Managed Entity ID:

This attribute provides a unique number for each instance of this managed entity. The value 0x00 is reserved. (R, Set-by-create) (mandatory) (2 bytes)

Downstream RFI Bands:

This configuration parameter is a table where each entry consists of an entry number (1 byte, first entry numbered 1) field, subcarrier index 1 (2 bytes) field, and subcarrier index 2 (2 bytes) field. The subcarrier indices are defined in section 8.1.10. This table defines the subset of downstream RFI bands breakpoints, as specified in the downstream PSD Mask managed entity, that are used to notch an RFI band. This subset consists of couples of consecutive subcarrier indices belonging to breakpoints [i1; i2], corresponding to the low level of the notch. The maximum number of RFI bands is 32. This attribute is valid only for G.992.5.

The specific interpolation around these points is defined in the relevant Recommendations (e.g. G.992.5). The CO-MIB shall define the RFI notches using breakpoints in the downstream PSD mask managed entity as specified in the relevant Recommendations (e.g. G.992.5).

The entries have default values of 0x00 for subcarrier index 1 and subcarrier index 2. Table entries for this attribute are added or modified using the set action. Setting an entry with a non-zero subcarrier index 1 and subcarrier index 2 implies insertion into the table. Setting an entry's subcarrier index 1 and subcarrier index 2 to 0 implies deletion from the table, if present. (R, W) (mandatory) (N*5 bytes where N is the number of RFI bands)

TableValid:

This Boolean attribute controls and reports the operational status of this downstream RFI bands attribute. If this attribute is true (coded as 0x01), then the downstream RFI bands represented in this managed entity have been impressed on the DSL equipment. If this attribute is false (coded as 0x00), then the downstream RFI bands represented in this managed entity have not been impressed on the DSL equipment. The default value is false. The value of this attribute can be modified by the ONU and OLT, as follows. If the OLT changes any of the RFI bands table entries or sets TableValid to false, then TableValid is set to false. If the TableValid is false and OLT sets TableValid to true, then the ONU will impress the downstream RFI bands data to the DSL equipment. (R, W) (mandatory) (1 byte)

Actions

Get: Get one or more attributes. Latch a snapshot (i.e. copy) of the current downstream RFI Bands and use 4 bytes to respond with the size of data which should be obtained using the “Get next” command.

Get next: Get the latched attribute values of the managed entity within the current snapshot.

Set: Generally, this action is used to set one or more entire attribute values. When used on the downstream RFI bands attribute, the set action either adds, modifies, or deletes table entries in downstream RFI bands. A maximum of 6 table entries can be added/modified/deleted by a single set action.

Notifications

None.

Managed Entity: ADSL ATU-C Performance Monitoring History Data

This managed entity represents the last completed 15-minute interval of collected performance monitoring data for the ATU-C-ATU-R ADSL modem path as seen from the ATU-C. Instances of this managed entity are created/deleted by the OLT after an instance of the corresponding physical path termination point ADSL UNI managed entity is created/deleted.

Relationships

One instance of this managed entity can exist for each instance of a physical path termination point ADSL UNI.

Attributes

Managed Entity ID:

This attribute provides a unique number for each instance of this managed entity. The assigned number is the same as the ID of the physical path termination point ADSL UNI with which this ATU-C Performance Monitoring History Data is associated. (R, W, Set-by-create) (mandatory) (2 bytes)

Interval End Time:

This attribute identifies the most recently finished 15-minute interval. It is a cyclic counter (modulo 0xFF (256)) that is incremented each time a new interval is finished and the attribute counters are updated. The value of this attribute is 0x00 during the first 15-minute interval that starts with the reception of the “synchronize time” action. The value is 0x01 during the first period after this, and so on. If this managed entity is created after the reception of the “synchronize time” action, the value of this attribute is set equal to the number of the last completed interval. The actual counters of this managed entity start counting directly. (R) (mandatory) (1 byte)

Threshold Data _{B-PON} ID:

This attribute provides a pointer to an instance of the threshold data B-PON managed entity (as defined in G.983.2) that contains the threshold values for the performance monitoring data collected by this managed entity. (R, W, Set-by-create) (mandatory) (2 bytes)

Loss of Frame Seconds:

This attribute is the count of seconds in the previous 15-minute interval when there was loss of framing. (R) (mandatory) (2 bytes)

Loss of Signal Seconds:

This attribute is the count of seconds in the previous 15-minute interval when there was loss of signal. (R) (mandatory) (2 bytes)

Loss of Link Seconds:

This attribute is the count of seconds in the previous 15-minute interval when there was loss of link. (R) (mandatory) (2 bytes)

Loss of Power Seconds:

This attribute is the count of seconds in the previous 15-minute interval when there was loss of power. (R) (mandatory) (2 bytes)

Errored Seconds:

This attribute is the count of errored seconds in the previous 15-minute interval. (R) (mandatory) (2 bytes)

Severely Errored Seconds:

This attribute is the count of severely errored seconds in the previous 15-minute Interval. (R) (mandatory) (2 bytes)

Line Initializations:

This attribute is the count of line initializations in the previous 15-minute interval. (R) (mandatory) (2 bytes)

Failed Line Initializations:

This attribute is a count of the total number of failed full initializations in the previous 15-minute interval. (R) (mandatory) (2 bytes)

Short Initialization:

This attribute is a count of the total number of fast retrains or short initializations attempted on the line (successful and failed) in the previous 15-minute interval. (R) (optional) (2 bytes)

Failed Short Initializations:

This attribute is a count of the total number of failed fast retrains or short initializations in the previous 15-minute interval. (R) (optional) (2 bytes)

FEC Seconds:

This attribute is the count of seconds in the previous 15-minute interval when there was a forward error correction anomaly. (R) (mandatory) (2 bytes)

Unavailable Seconds:

This attribute is the count of seconds in the previous 15-minute interval when the ATU-C was unavailable. (R) (mandatory) (2 bytes)

Actions

Create: Create an instance of this managed entity.

Delete: Delete an instance of this managed entity.

Get: Get one or more attributes.

Get Current Data: Get the current value of one or more attributes.

Set: Set one or more attributes.

Notifications

Threshold Crossing Alert:

This notification is used to notify the network management system when a threshold crossing alert (TCA) has been detected or cleared. The TCA change notification “on” is sent at the crossing of the threshold by the actual counter; the TCA change notification “off” is sent at the end of the 15 min period since that is when the actual counters are reset to 0x00. The event list for this entity is given in Table 5 below.

TABLE 5
ADSL Performance Monitoring History Data

| | Event | | |
|---|---|---|---|
| | Threshold | | Threshold Data |
| Number | Crossing Alert | Description | Counter Number* |
| 0 | Loss of Frame | Loss of Frame Seconds | 1 |
| | Seconds | threshold crossing | |
| 1 | Loss of Signal | Loss of Signal Seconds | 2 |
| | Seconds | threshold crossing | |
| 2 | Loss of Link | Loss of Link Seconds | 3 |
| | Seconds | threshold crossing | |
| 3 | Loss of Power | Loss of Power seconds | 4 |
| | Seconds | threshold crossing | |
| 4 | Errored | Errored seconds threshold | 5 |
| | Seconds | crossing | |
| 5 | Severely | Severely Errored seconds | 6 |
| | Errored | | |
| | Seconds | threshold crossing | |
| 6 | Line | Line Initializations | 7 |
| | Initializations | threshold crossing | |
| 7 | Failed Line | Failed Line Initializations | 8 |
| | Initializations | threshold crossing | |
| 8 | Short | Short Initializations | 9 |
| | Initializations | threshold crossing | |
| 9 | Failed Short | Failed Short Initializations | 10 |
| | Initializations | threshold crossing | |
| 10 | FEC Seconds | FEC Seconds threshold | 11 |
| | | crossing | |
| 11 | Unavailable | Unavailable Seconds | 12 |
| | Seconds | threshold crossing | |
| 12-255 | Reserved | | |

*This numbering is used with the associated threshold data _{B-PON} managed entity.
Threshold data counter 1 indicates the 1^{st} thresholded counter, etc.

Managed Entity: ADSL ATU-R Performance Monitoring History Data

This managed entity represents the last completed 15-minute interval of collected performance monitoring data of the ATU-C-ATU-R ADSL modem path as seen from the ATU-R. Instances of this managed entity are created/deleted by the OLT after an instance of the corresponding physical path termination point ADSL UNI managed entity is created/deleted.

Relationships

One instance of this managed entity can exist for each instance of a physical path termination point ADSL UNI.

Attributes

Managed Entity ID:

This attribute provides a unique number for each instance of this managed entity. The assigned number is the same as the ID of the physical path termination point ADSL UNI with which this ATU-R performance monitoring history data is associated. (R, Set-by-create) (mandatory) (2 bytes)

Interval End Time:

This attribute identifies the most recently finished 15-minute interval. It is a cyclic counter (modulo 0xFF (256)) that is incremented each time a new interval is finished and the attribute counters are updated. The value of this attribute is 0x00 during the first 15-minute interval that starts with the reception of the “synchronize time” action. The value is 0x01 during the first period after this, and so on. If this managed entity is created after the reception of the “synchronize time” action, the value of this attribute is set equal to the number of the last completed interval. The actual counters of this managed entity start counting directly. (R) (mandatory) (1 byte)

Threshold Data _{B-PON} ID:

This attribute provides a pointer to an instance of the threshold data B-PON managed entity (as set forth in reference G.983.2) that contains the threshold values for the performance monitoring data collected by this managed entity. (R, W, Set-by-create) (mandatory) (2 bytes)

Loss of Frame Seconds:

This attribute is the count of seconds in the previous 15-minute interval when there was loss of framing. (R) (mandatory) (2 bytes)

Loss of Signal Seconds:

This attribute is the count of seconds in the previous 15-minute interval when there was loss of signal. (R) (mandatory) (2 bytes)

Loss of Power Seconds:

This attribute is the count of seconds in the previous 15-minute interval when there was loss of power. (R) (mandatory) (2 bytes)

Errored Seconds:

This attribute is the count of errored seconds in the previous 15-minute interval. (R) (mandatory) (2 bytes)

Severely Errored Seconds:

This attribute is the count of severely errored seconds in the previous 15-minute interval. (R) (mandatory) (2 bytes)

FEC Seconds:

This attribute is the count of seconds in the previous 15-minute interval when there was a forward error correction anomaly. (R) (mandatory) (2 bytes)

Unavailable Seconds:

This attribute is the count of seconds in the previous 15-minute interval the ATU-R was unavailable. (R) (mandatory) (2 bytes)

Actions

Create: Create an instance of this managed entity.

Delete: Delete an instance of this managed entity.

Get: Get one or more attributes.

Get Current Data: Get the current value of one or more attributes.

Set: Set one or more attributes.

Notifications

Threshold Crossing Alert:

This notification is used to notify the network management system when a threshold crossing alert (TCA) has been detected or cleared. The TCA change notification “on” is sent at the crossing of the threshold by the actual counter; the TCA change notification “off” is sent at the end of the 15 min period since that is when the actual counters are reset to 0x00. The event list for this entity is given in Table 6 below

TABLE 6
ATU-R Performance Monitoring History Data

| | | | Threshold |
|---|---|---|---|
| | | | Data |
| | Event | | Counter |
| Number | Threshold Crossing Alert | Description | Number* |
| 0 | Loss of Frame Seconds | Loss of Frame Seconds | 1 |
| | | threshold crossing | |
| 1 | Loss of Signal Seconds | Loss of Signal Seconds | 2 |
| | | threshold crossing | |
| 2 | Loss of Power Seconds | Loss of Power seconds | 3 |
| | | threshold crossing | |
| 3 | Errored Seconds | Errored seconds | 4 |
| | | threshold crossing | |
| 4 | Severely Errored | Severely Errored | 5 |
| | Seconds | seconds threshold | |
| | | crossing | |
| 5 | FEC Seconds | FEC Seconds threshold | 6 |
| | | crossing | |
| 6 | Unavailable Seconds | Unavailable Seconds | 7 |
| | | threshold crossing | |
| 5-255 | Reserved | | |

*This numbering is used with the associated threshold data _{B-PON} managed entity.
Threshold data counter 1 indicates the 1^{st} thresholded counter, etc.

Managed Entity: ADSL ATU-C Channel Performance Monitoring History Data

This managed entity represents the last completed 15-minute interval of collected performance monitoring data of the ATU-C-ATU-R ADSL channel as seen from the ATU-C. Instances of this managed entity are created/deleted by the OLT after an instance of the corresponding physical path termination point ADSL UNI managed entity is created/deleted.

Relationships

One instance of this managed entity can exist for each instance of a physical path termination point ADSL UNI.

Attributes

Managed Entity ID:

This attribute provides a unique number for each instance of this managed entity. This 2-byte number is directly associated with the physical position of the UNI. The two most significant bits of the first byte are the bearer channel ID. The six least significant bits of the first byte are the slot ID (as defined in G.983.2). The second byte is the port ID with a value range from 0x01 to 0xFF (1 to 255): 0x01 is used for the leftmost/lowest port on a subscriber line card, 0x02 is used for the next right/upper port, and so forth. (R) (mandatory) (2 bytes)

Interval End Time:

This attribute identifies the most recently finished 15-minute interval. It is a cyclic counter (modulo 0xFF (256)) that is incremented each time a new interval is finished and the attribute counters are updated. The value of this attribute is 0x00 during the first 15-minute interval that starts with the reception of the “synchronize time” action. The value is 0x01 during the first period after this, and so on. If this managed entity is created after the reception of the “synchronize time” action, the value of this attribute is set equal to the number of the last completed interval. The actual counters of this managed entity start counting directly. (R) (mandatory) (1 byte)

Threshold Data _{B-PON} ID:

This attribute provides a pointer to an instance of the threshold data B-PON managed entity that contains the threshold values for the performance monitoring data collected by this managed entity. (R, W. Set-by-create) (mandatory) (2 bytes)

Corrected Blocks:

This attribute is the count of all blocks received with errors that were corrected on this channel within the previous 15-minute interval. (R) (mandatory) (4 bytes)

Uncorrected Blocks:

This attribute is the count of all blocks received with uncorrectable errors on this channel within the previous 15-minute interval. (R) (mandatory) (4 bytes)

Transmitted Blocks:

This attribute is the count of all encoded blocks transmitted on this channel within the previous 15-minute interval. (R) (mandatory) (4 bytes)

Received Blocks:

This attribute is the count of all encoded blocks received on this channel within the previous 15-minute interval. (R) (mandatory) (4 bytes)

Code Violations:

This attribute is the count of CRC-8 anomalies in the bearer channel in the previous 15-minute interval. (R) (mandatory) (2 bytes)

Forward Error Corrections:

This attribute is the count of FEC anomalies in the bearer channel in the previous 15-minute interval. (R) (mandatory) (2 bytes)

Actions

Create: Create an instance of this managed entity.

Delete: Delete an instance of this managed entity.

Get: Get one or more attributes.

Get Current Data: Get the current value of one or more attributes.

Set: Set one or more attributes.

Notifications

Threshold Crossing Alert:

This notification is used to notify the network management system when a threshold crossing alert (TCA) has been detected or cleared. The TCA change notification “on” will be sent at the crossing of the threshold by the actual counter; the TCA change notification “off” will be sent at the end of the 15 min period since that is when the actual counters are reset to 0x00. The event list for this entity is given in Table 7.

TABLE 7
ATU-C Channel Performance Monitoring History Data

| | Event | | Threshold Data |
|---|---|---|---|
| | Threshold Crossing | | Counter |
| Number | Alert | Description | Number* |
| 0 | Corrected Blocks | Corrected Blocks | 1 |
| | | threshold crossing | |
| 1 | Uncorrected Blocks | Uncorrected Blocks | 2 |
| | | threshold crossing | |
| 2 | Code Violations | Code Violation threshold | 3 |
| | | crossing | |
| 3 | Forward Error | FEC threshold crossing | 4 |
| | Corrections | | |
| 4-255 | Reserved | | |

*This numbering is used with the associated threshold data _{B-PON} managed entity.
Threshold data counter 1 indicates the 1^{st} thresholded counter, etc.

Managed Entity: ADSL ATU-R Channel Performance Monitoring History Data

This managed entity represents the last completed 15 minute interval of collected performance monitoring data for the ATU-C-ATU-R ADSL channel as seen from the ATU-R. Instances of this managed entity are created/deleted by the OLT after an instance of the corresponding physical path termination point ADSL UNI managed entity is created/deleted.

Relationships

One instance of this managed entity can exist for each instance of a physical path termination point ADSL UNI.

Attributes

Managed Entity ID:

This attribute provides a unique number for each instance of this managed entity. This 2-byte number is directly associated with the physical position of the UNI. The two most significant bits of the first byte are the bearer channel ID. The six least significant bits of the first byte are the slot ID (defined in G.983.2). The second byte is the port ID with a value range from 0x01 to 0xFF (1 to 255): 0x01 is used for the leftmost/lowest port on a subscriber line card, 0x02 is used for the next right/upper port, and so forth (R) (mandatory) (2 bytes)

Interval End Time:

This attribute identifies the most recently finished 15-minute interval. It is a cyclic counter (modulo 0xFF (256)) that is incremented each time a new interval is finished and the attribute counters are updated. The value of this attribute is 0x00 during the first 15-minute interval that starts with the reception of the “synchronize time” action. The value is 0x01 during the first period after this, and so on. It this managed entity is created after the reception of the “synchronize time” action, the value of this attribute is set equal to the number of the last completed interval. The actual counters of this managed entity start counting directly. (R) (mandatory) (1 byte)

Threshold Data _{B-PON} ID:

This attribute provides a pointer to an Instance of the threshold data B-PON managed entity that contains the threshold values for the performance monitoring data collected by this managed entity. (R, W, Set-by-create) (mandatory) (2 bytes)

Corrected Blocks:

This attribute is the count of all blocks received with errors that were corrected on this channel within the previous 15-minute interval. (R)(mandatory) (4 bytes)

Uncorrected Blocks:

This attribute is the count of all blocks received with uncorrectable errors on this channel within the previous 15-minute interval. (R)(mandatory) (4 bytes)

Transmitted Blocks:

This attribute is the count of all encoded blocks transmitted on this channel within the previous 15-minute interval. (R) (mandatory) (4 bytes)

Received Blocks:

This attribute is the count of all encoded blocks received on this channel within the previous 15-minute interval. (R) (mandatory) (4 bytes)

Code Violations:

This attribute is the count of CRC-8 anomalies in the bearer channel in the previous 15 minute interval. (R) (mandatory) (2 bytes)

Forward Error Corrections:

This attribute is the count of FEC anomalies in the bearer channel in the previous 15-minute interval. (R) (mandatory) (2 bytes)

Actions

Create: Create an instance of this managed entity.

Delete: Delete an instance of this managed entity_{—}

Get: Get one or more attributes.

Get Current Data: Get the current value of one or more attributes.

Set: Set one or more attributes.

Notifications

Threshold Crossing Alert:

This notification is used to notify the management system when a threshold crossing alert (TCA) has been detected or cleared. The TCA change notification “on” is sent at the crossing of the threshold by the actual counter; the TCA change notification “off” is sent at the end of the 15 minute period since that is when the actual counters are reset to 0x00. The event list for this entity is given in Table 8 below.

TABLE 8
ATU-R Channel Performance Monitoring History Data

| | Event | | |
|---|---|---|---|
| | Threshold | | Threshold Data |
| Number | Crossing Alert | Description | Counter Number* |
| 0 | Corrected Blocks | Corrected Blocks | 1 |
| | | threshold crossing | |
| 1 | Uncorrected | Uncorrected Blocks | 2 |
| | Blocks | threshold crossing | |
| 2 | Code Violations | Code Violation threshold | 3 |
| | | crossing | |
| 3 | Forward Error | FEC threshold crossing | 4 |
| | Corrections | | |
| 4-255 | Reserved | | |

*This numbering is used with the associated threshold data _{B-PON} managed entity.
Threshold data counter 1 indicates the 1^{st} thresholded counter, etc.

Managed Entity: TC Adaptor Performance Monitoring History Data ADSL

This managed entity represents the last completed 15-minute interval collected performance monitoring of the ATU-C-ATU-R ATM data path. Instances of this managed entity are created/deleted by the OLT after an instance of the corresponding physical path termination point ADSL UNI managed entity is created/deleted.

Relationships

One instance of this managed entity can exist for each instance of a physical path termination point ADSL UNI.

Attributes

Managed Entity ID:

This attribute provides a unique number for each instance of this managed entity. The assigned number is the same as the ID of the physical path termination point ADSL UNI with which this TC Adaptor performance monitoring history data is associated. (R, Set-by-create) (mandatory) (2 bytes)

Interval End Time:

This attribute identifies the most recently finished 15 minute interval. It is a cyclic counter (modulo 0xFF (256)) that is incremented each time a new interval is finished and the attribute counters are updated. The value of this attribute is 0x00 during the first 15-minute interval that starts with the reception of the “synchronize time” action. The value is 0x01 during the first period after this, and so on. It this managed entity is created after the reception of the “synchronize time” action, the value of this attribute is set equal to the number of the last completed interval. The actual counters of this managed entity start counting directly. (R) (mandatory) (1 byte)

Threshold Data _{B-PON} ID:

This attribute provides a pointer to an instance of the threshold data B-PON managed entity that contains the threshold values for the performance monitoring data collected by this managed entity. (R, W, Set-by-create) (mandatory) (2 bytes)

Near-End HEC Violation Count:

The near-end HEC violation count performance parameter is a count of the number of occurrences of a near-end HEC anomaly in true ATM data path. (R) (mandatory) (2 bytes)

Near-End Delineated Total Cell Count (CD-P):

The near-end delineated total cell count performance parameter is a count of the total number of cells passed through the cell delineation and HEC function process operating on the ATM data path while in the SYNC state. (R) (mandatory) (4 bytes)

Near-End User Total Cell Count:

The near-end user total cell count performance parameter is a count of the total number of cells in the ATM data path delivered at the V-C (for ATU-C) or T-R (for ATU-R) Interface. (R) (mandatory) (4 bytes)

Near-End Idle Cell Bit Error Count:

The near-end idle bit error count performance parameter is a count of the number of bit errors in the idle cell payload received in the ATM data path at the near-end. (R) (mandatory) (2 bytes)

Far-End HEC Violation Count:

The far-end HEC violation count performance parameter is a count of the number of occurrences of a far-end HEC anomaly in the ATM data path. (R) (mandatory) (2 bytes)

Far-End Delineated Total Cell Count:

The far-end delineated total cell count performance parameter is a count of the total number of cells passed through the cell delineation process and HEC function operating on the ATM data path while in the SYNC state. (R) (mandatory) (4 bytes)

Far-End User Total Cell Count:

The far-end use total cell count performance parameter is a count of the total number of cells in the ATM data path delivered at the V-C (for ATU-C) or T-R (for ATU-R) interface. (R) (mandatory) (4 bytes)

Far-End Idle Cell Bit Error Count:

The far-end idle bit error count performance parameter is a count of the number of bit errors in the idle cell payload received in the ATM data path at the far-end. (R) (mandatory) (2 bytes)

Actions

Create: Create an instance of this managed entity.

Delete: Delete an instance of this managed entity.

Get: Get one or more attributes.

Get Current Data: Get the current value of one or more attributes.

Set: Set one or more attributes.

Notifications

Threshold Crossing Alert:

This notification is used to notify the management system when a threshold crossing alert (TCA) has been detected or cleared. The TCA change notification “on” is sent at the crossing of the threshold by the actual counter; the TCA change notification “off” is sent at the end of the 15-minute period since that is when the actual counters are reset to 0x00. The event list for this entity is given in Table 9 below.

TABLE 9
TC Adaptor Performance Monitoring History Data ADSL

| | | | Threshold |
|---|---|---|---|
| | | | Data |
| | Event | | Counter |
| Number | Threshold Crossing Alert | Description | Number* |
| 0 | Near-end HEC violation | Near-end HEC violation | 1 |
| | | count threshold crossing | |
| 1 | Near-end Idle Cell Bit | Near-end Idle Cell Bit | 2 |
| | Error Count | Error Count threshold | |
| | | crossing | |
| 2 | Far-end HEC violation | Far-end HEC violation | 3 |
| | count | count threshold crossing | |
| 3 | Far-end Idle Cell Bit | Far-end Idle Cell Bit | 4 |
| | Error Count | Error Count threshold | |
| | | crossing | |
| 4-255 | Reserved | | |

*This numbering is used with the associated threshold data _{B-PON} managed entity.
Threshold data counter 1 indicates the 1^{st} thresholded counter, etc.

Table 10 below lists the OMCI protocol managed entities for operation of a PON with a VDSL network according to the teachings of the present invention.

TABLE 10
VDSL Managed Entities

| | Required/ | | |
|---|---|---|---|
| Managed Entity | Optional | Description | Section |
| Physical Path Termination | CR | Used for the physical path | 8.2.1 |
| Point VDSL UNI | | termination point at a VDSL | |
| | | connection | |
| VDSL Band Plan Configuration | CR | Parameters used to configure a | 8.2.7 |
| Profile | | VDSL Band Plan | |
| | | Configuration Profile. | |
| VDSL Channel Configuration | CR | Parameters used to configure | 8.2.6 |
| Profile | | a VDSL Channel | |
| | | Configuration Profile | |
| VDSL Channel Data | CR | Contains the Channel | 8.2.4 |
| | | Parameters for VDSL Fast | |
| | | and Slow channels | |
| VDSL Line Configuration | CR | Parameters used to configure | 8.2.5 |
| Profile | | a VDSL Line Configuration | |
| | | Profile | |
| VDSL VTU-O Channel | O | Performance monitoring data | 8.2.10 |
| Performance Monitoring | | for a VDSL VTU-O channel | |
| History Data | | | |
| VDSL VTU-O Physical Data | CR | Contains the Physical Layer | 8.2.2 |
| | | Parameters for a VTU-O | |
| VDSL VTU-O Physical | O | Monitoring Data for a VDSL | 8.2.8 |
| Interface Monitoring History | | VTU-O Physical Interface | |
| Data | | | |
| VDSL VTU-R Channel | O | Performance monitoring data | 8.2.11 |
| Performance Monitoring | | for an VDSL VTU-R channel | |
| History Data | | | |
| VDSL VTU-R Physical Data | CR | Contains the Physical Layer | 8.2.3 |
| | | Parameters for a VTU-R | |
| VDSL VTU-R Physical | O | Monitoring Data for a VDSL | 8.2.9 |
| Interface Monitoring History | | VTU-R Physical Interface | |
| Data | | | |

Managed Entity: Physical Path Termination Point VDSL UNI

This managed entity represents the point at a VDSL connection in the ONU where physical paths terminate and physical path level functions (e.g., path overhead functions) are performed. Instances of this managed entity are automatically created/deleted by the ONU upon the creation/deletion of a subscriber line card of VDSL type. If the subscriber line card of VDSL type is a plug-in unit, the number of managed entities automatically created is the maximum number supportable by the subscriber line card slot of the ONU. This allows the creation of these managed entities before the unit is plugged-in. The physical path termination point VDSL UNI is automatically created when the subscriber line card of type VDSL is created. On auto creation the three profile pointers within the managed entity are set to their default values of 0x00. However, the physical path termination point VDSL UNI must refer to three valid profiles before it can be operational.

Relationships

One or more instances of this managed entity shall be contained in an instance of a subscriber line card managed entity classified as VDSL type.

Attributes

Managed Entity ID:

This attribute provides a unique number for each instance of this managed entity. This 2-byte number is directly associated with the physical position of the UNI. The first byte is the slot ID (defined in G.983.2/Section 7.1.3). The second byte is the port ID with a value range from 0x01 to 0xFF (1 to 255): 0x01 is used for the leftmost/lowest port on a subscriber line card, 0x02 is used for the next right/upper port, and so forth. (R) (mandatory) (2 bytes)

Loopback Configuration:

This attribute represents the loopback configuration of this physical interface. Value 0x00: no loopback; value 0x01: loopback2(“Loopback2” refers to a loopback at the local VDSL modem). The OLT can execute a physical level loopback test after loopback is set. Upon autonomous instantiation, the value 0x00 is set. (R, W) (mandatory) (1 byte)

Administrative State:

This attribute activates (unlock: value 0x00) and deactivate (lock: value 0x01) the functions performed by instances of this managed entity. (R, W) (mandatory) (1 byte)

Operational State:

This attribute indicates whether or not this managed entity is capable of performing its task. The operational state reflects the perceived ability to receive or to generate a valid signal. Valid values are enabled (0x00) and disabled (0x01). (R) (optional) (1 byte)

Availability State:

This attribute indicates whether the hardware to support this UNI is available on the plugged in line card. Valid values are available (0), not available (1) and unknown (2). (R) (optional) (1 byte)

VDSL Line Coding Type:

This data type is used as the syntax for the VDSL line code. Attributes with this syntax identify the line coding used. The three values are: other(1) indicating none of the following, mcm(2) indicating multiple carrier modulation and scm(3) indicating single carrier modulation. (R) (mandatory) (1 byte)

VDSL Line Type:

Defines the type of VDSL physical line entity that exists by defining whether and how the line is channelized. If the line is channelized, the value will be other than noChannel(1). This object defines which channel type(s) are supported. Defined values are: noChannel(1)—no channels exist, fastOnly(2)—only fast channel exists, slowOnly(3)—only slow channel exists, fastOrSlow(4)—either fast or slow channel exist, but only one at a given time and fastAndSlow(5)—both fast and slow channels exist. (R) (mandatory) (1 byte)

ARC:

This attribute controls alarm reporting from this managed entity. Valid values are “off” (alarm reporting allowed immediately) and “on” (alarm reporting inhibited). Upon initial installation and provisioning of the ONU, this attribute may be set to “on” or “off” for the time interval specified by “ARCInterval.” Similarly, this attribute may be set to “off.” If the attribute is set to “on,” then alarm reporting is inhibited until this managed entity detects a valid signal for the time interval specified by “ARCInterval.” The default value is “on”. (R, W) (optional) (1 byte)

ARCInterval:

This attribute provides a provisionable length of time. Units are given in minutes. The default value is 2. (R, W) (optional) (1 byte)

VDSL Line Configuration Profile ID:

This attribute provides a pointer to an instance of the VDSL line configuration profile managed entity (described below) that contains the data necessary for initializing a VDSL modem. The default value 0x00, used when the managed entity is created, indicates that this managed entity does not point to a line configuration profile. (R, W) (mandatory) (2 bytes)

VDSL Channel Configuration Profile ID:

This attribute provides a pointer to an instance of the VDSL channel configuration profile managed entity that contains the data necessary for channelizing a VDSL connection. The default value 0x00, set when the managed entity is created, indicates that this managed entity does not point to a channel configuration profile. (R, W) (mandatory) (2 bytes)

VDSL Band Plan Configuration Profile ID:

This attribute provides a pointer to an instance of the VDSL band plan configuration profile managed entity that contains the data necessary to set up a VDSL connection. The default value 0x00, set when the managed entity is created, indicates that this managed entity does not point to band plan configuration profile. (R, W) (mandatory) (2 bytes)

Actions

Get: Get one or more attributes.

Set: Set one or more attributes.

Notifications

Attribute value change:

This notification is used to report autonomous changes of attributes of this managed entity. The notification identifies the attribute and its new value. The attribute value changes for this managed entity are given in Table 11 below.

TABLE 11

| | Attribute Value | |
|---|---|---|
| Number | Change | Description |
| 1-2 | N/A | |
| 3 | OpState | Operational state |
| 4-11 | N/A | |
| 12-16 | Reserved | |

Alarm:

This notification is used to notify the network management system when a failure has been detected or cleared. Both ONU and OLT should know the alarm list used by this entity. The alarms for this entity are given in Table 11.

TABLE 12

| Number | Alarm | Description |
|---|---|---|
| 0 | NE_LOF | Near End (VTU-O) Loss of Framing |
| 1 | NE_LOS | Near End (VTU-O) Loss of Signal |
| 2 | NE_LOP | Near End (VTU-O) Loss of Power |
| 3 | NE_LOSQ | Near End (VTU-O) Loss of Signal Quality |
| 4 | NE_LOL | Near End (VTU-O) Loss of Link |
| 5 | FE_LOF | Far End (VTU-R) Loss of Framing |
| 6 | FE_LOS | Far End (VTU-R) Loss of Signal |
| 7 | FE_LOP | Far End (VTU-R) Loss of Power |
| 8 | FE_LOSQ | Far End (VTU-R) Loss of Signal Quality |

Managed Entity: VDSL VTU-O Physical Data

This managed entity represents the physical status of the VDSL termination unit (ONU or VTU-O) In a VDSL connection in the ONU. An instance of this managed entity is automatically created/deleted by the ONU upon the creation/deletion of a subscriber line card of VDSL type.

Relationships

One or more instances of this managed entity is contained in an instance of a subscriber line card managed entity classified as VDSL type.

Attributes

Managed Entity ID

This attribute provides a unique number for each instance of this managed entity. This 2-byte number is directly associated with the physical position of the UNI. The first byte is the slot ID. The second byte is the port ID with a value range from 0x01 to 0xFF (1 to 255). (R) (mandatory) (2 bytes)

Line Transmit Rate:

Indicates the current VTU-O line transmit rate in kbit/s. This value is less than or equal to the current attainable rate. Note: 1 kbit/s=1000 bit/s. (R) (mandatory) (4 bytes)

Serial Number Parts 1 and 2:

This attribute comprises a vendor specific string that identifies the equipment vendor. It comprises up to 32 ASCII characters. Part 1 comprises the first 16 characters and part 2 the last 16 characters. (R) (mandatory) (16 bytes per part)

Vendor ID:

The vendor ID code is a copy of the binary vendor identification field expressed as readable characters in hexadecimal notation. (R) (mandatory) (16 bytes)

Version Number:

The vendor specific version number sent by this VTU as part of the initialization messages. It is a copy of the binary version number field expressed as readable characters in hexadecimal notation. (R) (mandatory) (16 bytes)

Current Status:

The attribute indicates current state of the VTU-O in the form of a bit-map of possible conditions. The various bit positions are

0—no defect—There are no defects on the line.

1—loss of framing—VTU-O failure due to not receiving a valid frame.

2—loss of signal—VTU-O failure due to not receiving signal.

3—loss of power—VTU-O failure due to loss of power.

4 —loss of signal quality—Loss of signal quality is declared when the noise margin falls below the minimum noise margin, or the bit-error-rate exceeds 10⁻⁷.

5—loss of link—VTU-O failure due to inability to link with peer VTU. Set whenever the transceiver is in the ‘warm start’ state.

6—data initialization failure—VTU-O failure during initialization due to bit errors corrupting startup exchange data.

7—configuration initialization failure—VTU-O failure during initialization because the peer VTU (the VTU-R, i.e., the peer of the VTU-O is the VTU-R) since the peer of the VTU is unable to support the requested configuration.

8—protocol initialization failure—VTU-O failure during initialization because of an incompatible protocol used by the peer VTU.

9—no peer VTU present—VTU-O failure during initialization due to lack of detection of an activation sequence from peer VTU. (R) (mandatory) (2 bytes)

Current Output Power:

Measured total output power transmitted by this VTU in steps of 0.1 dBm, as reported during the last activation sequence. The effective range is 0 (0) to +16 (160) dBm. (R) (mandatory) (1 byte)

Current SNR Margin:

Noise margin as seen by this VTU with respect to its received signal in steps of 0.25 dB. The effective range is −31.75 (−127) to +31.75 (127) dB. (R) (mandatory) (1 byte)

Current Attenuation:

Measured difference in the total power transmitted by the peer VTU and the total power received by this VTU. The effective range is 0 (0) to +63.75 (255) dB. (R) (mandatory) (1 byte)

Current Attainable Rate:

Indicates the maximum currently attainable line transmit rate by the VTU-O in kbit/s. This value will be equal to or greater than the current line rate. Note: 1 kbit/s=1000 bit/s. (R) (mandatory) (4 bytes)

Current Loop Length Estimate:

Estimated loop length in feet assuming a 26 AWG (0.4 mm) loop. (R) (mandatory) (2 bytes)

Actions

Get: Get one or more attributes.

Notifications

None.

Managed Entity: VDSL VTU-R Physical Data

This managed entity represents the physical status of the VDSL termination unit (remote) (VTU-R) in a VDSL connection in the ONU. An instance of this managed entity is automatically created/deleted by the ONU upon the creation/deletion of a subscriber line card of VDSL type.

Relationships

One or more instances of this managed entity is contained in an instance of a subscriber line card managed entity classified as VDSL type.

Attributes

Managed Entity ID:

This attribute provides a unique number for each instance of this managed entity. This 2-byte number is directly associated with the physical position of the UNI. The first byte is the slot ID. The second byte is the port ID with a value range from 0x01 to 0xFF (1 to 255). (R) (mandatory) (2 bytes)

Line Transmit Rate:

Indicates the current VTU-R line transmit rate in kbit/s. This value will be less than or equal to the current attainable rate. Note: 1 kbit/s=1000 bit/s. (R) (mandatory) (4 bytes)

Serial Number Parts 1 and 2:

This attribute comprises a vendor specific string that identifies the vendor equipment. Part 1 of the attribute contains the first 16 characters and part 2 the next 16 characters. (R) (mandatory) (16 bytes per part)

Vendor ID:

The vendor ID code is a copy of the binary vendor identification field expressed as readable characters in hexadecimal notation. (R) (mandatory) (16 bytes)

Version Number:

The vendor specific version number sent by this VTU as part of the initialization messages. It is a copy of the binary version number field expressed as readable characters in hexadecimal notation. (R) (mandatory) (16 bytes)

Current Status:

Indicates current state of the VTU line according to a bit-map of possible conditions. The various bit positions are

0—no defect—There are no defects on the line.

1—loss of framing—VTU failure due to not receiving a valid frame.

2—loss of signal—VTU failure due to not receiving signal.

3—loss of power—VTU failure due to loss of power.

4—loss of signal quality—Loss of signal quality is declared when the noise margin falls below the minimum noise margin, or the bit-error-rate exceeds 10⁻⁷. (R) (mandatory) (1 bytes)

Current Output Power:

Measured total output power, as reported during the last activation sequence, transmitted by this VTU in steps of 0.1 dBm. The effective range is 0 (0) to +16 (160) dBm: (R) (mandatory) (1 byte)

Current SNR Margin:

Noise margin as seen by this VTU with respect to its received signal in 0.25 dB increments. The effective range is −31.75 (−127) to +31.75 (127) dB. (R) (mandatory) (1 byte)

Current Attenuation:

Measured difference in the total power transmitted by the peer VTU and the total power received by this VTU. The effective range is 0 (0) to +63.75 (255) dB. (R) (mandatory) (1 byte)

Current Attainable Rate:

Indicates the maximum currently attainable line transmit rate by the VTU-R in kbit/s. This value will be equal to or greater than the current line rate. Note: 1 kbit/s=1000 bit/s. (R) (mandatory) (4 bytes)

Actions

Get: Get one or more attributes.

Notifications

None.

Managed Entity: VDSL Channel Data

This managed entity represents the physical status of the VDSL fast and slow channels in a VDSL connection in the ONU. An instance of this managed entity is automatically created/deleted by the ONU upon the creation/deletion of a subscriber line card of VDSL type.

Relationships

One or more instances of this managed entity shall be contained in an instance of a subscriber line card managed entity classified as VDSL type.

Attributes

Managed Entity ID:

This attribute provides a unique number for each instance of this managed entity. This 2-byte number is directly associated with the physical position of the UNI. The first byte is the slot ID. The second byte is the port ID with a value range from 0x00 to 0xFF (1 to 255). (R) (mandatory) (2 bytes)

Current Interleave Delay Down:

Downstream interleave delay for this channel in milliseconds. Interleave delay defines the mapping (relative spacing) between subsequent input bytes at the interleaver input and their placement in the bit stream at the interleaver output. Larger numbers provide greater separation between consecutive input bytes in the output bit stream allowing for improved impulse noise immunity at the expense of payload latency. (R) (mandatory) (1 byte)

Current Fast Payload Rate Down:

Actual fast channel downstream data rate, in kbit/s. Note: 1 kbit/s=1000 bit/s. (R) (mandatory) (4 bytes)

Current Slow Payload Rate Down:

Actual slow downstream data rate, in kbit/s. Note: 1 kbit/s=1000 bit/s. (R) (mandatory) (4 bytes)

Current Fast CRC Block Length Down:

Indicates the length of the downstream fast channel data-block, in bytes, on which the CRC operates. (R) (mandatory) (2 bytes)

Current Slow CRC Block Length Down:

Indicates the length of the downstream slow channel data-block, in bytes, on which the CRC operates. (R) (mandatory) (2 bytes)

Current Slow Burst Protect Down:

Actual level of downstream impulse noise (burst) protection, in microseconds, for the slow channel. (R) (mandatory) (2 bytes)

Current Fast FEC Down:

Actual downstream forward error correction (FEC) redundancy, in percent, as related to overhead for the fast channel, (R) (mandatory) (1 byte)

Current Interleave Delay Up:

Downstream interleave delay for this channel in milliseconds. Interleave delay applies only to the interleave (slow) channel and defines the mapping (relative spacing) between subsequent input bytes at the interleaver input and their placement in the bit stream at the interleaver output. Larger numbers provide greater separation between consecutive input bytes in the output bit stream allowing for improved impulse noise immunity at the expense of payload latency. In the case where the interface type is fast, this attribute is set to a value of zero. (R) (mandatory) (1 byte)

Current Fast Payload Rate Up:

Actual fast channel upstream data rate, in kbit/s. Note: 1 kbit/s=1000 bit/s. (R) (mandatory) (4 bytes)

Current Slow Payload Rate Up:

Actual slow upstream data rate, in kbit/s. Note: 1 kbit/s=1000 bit/s. (R) (mandatory) (4 bytes)

Current Fast CRC Block Length Up:

Indicates the length of the upstream fast channel data-block, in bytes, on which the CRC operates. (R) (mandatory) (2 bytes)

Current Slow CRC Block Length Up:

Indicates the length of the upstream slow channel data-block, in bytes, on which the CRC operates. (R) (mandatory) (2 bytes)

Current Slow Burst Protect Up:

Actual level of upstream impulse noise (burst) protection, in microseconds, for the slow channel. (R) (mandatory) (2 bytes)

Current Fast FEC Up:

Actual upstream forward error correction (FEC) redundancy, in percent, as related to overhead, for the fast channel. (R) (mandatory) (1 byte)

Actions

Get: Get one or more attributes.

Notifications

None.

Managed Entity: VDSL Line Configuration Profile

An instance of this managed entity represents a VDSL line configuration profile supported on the ONU. Zero or more VDSL physical path termination points can reference an instance of a VDSL line configuration profile managed entity. Instances of this managed entity are created and deleted by the ONU on request of the OLT.

Relationships

Zero or more instances of this managed entity are contained in an ONU. One or more instances of this managed entity shall be contained in an ONU containing instances of physical path termination point VDSL UNI.

Attributes

Managed Entity ID:

This attribute provides a unique number for each instance of this managed entity. The value 0x00 is reserved. (R, W, Set-be-create) (mandatory) (2 bytes)

Down Rate Mode:

Specifies the rate selection behavior for the line in the downstream direction:

manual(1) forces the rate to the configured rate and adaptAtInit(2) adapts the line based upon line quality. (R, W, Set-by-Create) (mandatory) (1 byte)

Up Rate Mode:

Specifies the rate selection behavior for the line in the upstream direction:

manual(1) forces the rate to the configured rate and adaptAtInit(2) adapts the line based upon line quality. (R, W, Set-by-Create) (mandatory) (1 byte)

Down Max Power:

Specifies the maximum aggregate downstream power level in the range 0 (0) to 14.5 dBm (58) in 0.25 dBm intervals. (R, W, Set-by-Create) (mandatory) (1 byte)

Up Max Power:

Specifies the maximum aggregate upstream power level in the range 0 (0) to 14.5 dBm (SB) in 0.25 dBm intervals. (R, W, Set-by-Create) (mandatory) (1 byte)

Down Max SNR Margin:

Specifies the maximum downstream signal/noise ratio margin in units of 0.25 dB, for a range of 0 (0) to 31.75 dB (127). (R, W, Set-by-Create) (mandatory) (1 byte)

Down Min SNR Margin:

Specifies the minimum downstream signal/noise ratio margin in units of 0.25 dB, for a range of 0 (0) to 31.75 dB (127). (R, W, Set-by-Create) (mandatory) (1 byte)

Down Target SNR Margin:

Specifies the target downstream signal/noise ratio margin in units of 0.25 dB, for a range of 0 (0) to 31.75 dB (127). This is the noise margin the transceivers must achieve with a BER of 10⁻⁷ or better to successfully complete initialization. (R, W, Set-by-Create) (mandatory) (1 byte)

Up Max SNR Margin:

Specifies the maximum upstream signal/noise ratio margin in units of 0.25 dB, for a range of 0 (0) to 31.75 dB (127). (R, W, Set-by-Create) (mandatory) (1 byte)

Up Min SNR Margin:

Specifies the minimum upstream signal/noise ratio margin in units of 0.25 dB, for a range of 0 (0) to 31.75 dB (127). (R, W, Set-by-Create) (mandatory) (1 byte)

Up Target SNR Margin:

Specifies the target upstream signal/noise ratio margin in units of 0.25 dB, for a range of 0 (0) to 31.75 dB (127). This is the noise margin the transceivers must achieve with a BER of 10⁻⁷ or better to successfully complete initialization. (R, W, Set-by-Create) (mandatory) (1 byte)

Down PBO Control:

Downstream power back off (PBO) control for this line. For transceivers that do not support downstream PBO control, this object must be fixed at disabled(1). If auto(2) is selected, the transceiver automatically adjusts the power back off. If manual(3) is selected, then the transceiver uses the down PBO level. (R, W, Set-by-Create) (mandatory) (1 byte)

Up PBO Control:

Upstream power back off (PBO) control for this line. For transceivers that do not support upstream PBO control, this object must be fixed at disabled(1). If auto(2) is selected, the transceiver automatically adjusts the power back off. If manual(3) is selected the transceiver uses the up PBO level. (R, W, Set-by-Create) (mandatory) (1 byte)

Down PBO Level:

Specifies the downstream back off level to be used when the down PBO control attribute is set to manual(3). Valid range is 0 dB (0) to 40 dB (160) in 0.25 dB intervals. (R, W, Set-by-Create) (mandatory) (1 byte)

Up PBO Level:

Specifies the upstream back off level to be used when the up PBO control is set to manual(3). Valid range is 0 dB (0) to 40 dB (160) in 0.25 dB intervals. (R, W, Set-by-Create) (mandatory) (1 byte)

Line Type:

This parameter provisions the VDSL physical entity at start-up by defining whether and how the line will be channelized, i.e. which channel type(s) are supported. If the line is to be channelized, the value will be other than noChannel(1). Defined values are: noChannel(1)—no, channels exist, fastOnly(2)—only the fast channel exists, slowOnly(3)—only the slow channel exists, fastOrSlow(4)—either the fast or the slow channel exists, but only one at a time, fastAndSlow(5)—both fast and slow channels exist. (R, W, Set-by-Create) (mandatory) (1 byte)

Actions

Create: Create an instance of this managed entity.

Delete: Delete an instance of this managed entity.

Get: Get one or more attributes.

Set: Set one or more attributes.

Notifications

None.

Managed Entity: VDSL Channel Configuration Profile

An instance of this managed entity represents a VDSL channel configuration profile supported on the ONU. Zero or more VDSL physical path termination points can reference an instance of the VDSL channel configuration profile managed entity. Instances of this managed entity are created and deleted by the ONU on request of the OLT.

Relationships

Zero or more instances of this managed entity are contained in an ONU. One or more instances of this managed entity are contained in an ONU containing instances of physical path termination point VDSL UNI.

Attributes

Managed Entity ID:

This attribute provides a unique number for each instance of this managed entity. The value 0x00 is reserved. (R, Set-by-create) (mandatory) (2 bytes)

Downstream Rate Ratio:

This attribute is the configured allocation ratio of excess downstream transmit bandwidth between fast and slow channels. This attribute applies only when two-channel mode and adaptAtInit are supported. (i.e., the setting of the up/down rate mode in the VDSL line configuration profile. When these fields are set to adaptAtInit(2), the two VDSL modems set the line rate based on the line conditions at initialization (training) Distribute bandwidth on each channel in excess of the corresponding minimum transmit bit rate so that:
Rate Change Ratio=[Fast/(Fast+Slow)]*100
In other words this value is the fast channel percentage. Valid range is 0 to 100. (R, W, Set-by-Create) (optional) (1 byte)
Upstream Rate Ratio:

This attribute is the configured allocation ratio of excess upstream transmit bandwidth between fast and slow channels. The attribute applies only when two-channel mode and adaptAtInit are supported. The bandwidth on each channel in excess of the corresponding minimum transmit bit rate is distributed so that:
Rate Change Ratio=[Fast/(Fast+Slow)]*100
In other words this value is the fast channel percentage. Valid range is 0 to 100. (R, W, Set-by-Create) (optional) (1 byte)
Downstream Slow Maximum Data Rate:

This attribute specifies the maximum downstream slow channel data rate in steps of 64K bits/s. The maximum aggregate downstream transmit speed of the line can be derived from the sum of the maximum downstream fast and slow channel data rates. (R, W, Set-by-Create) (mandatory) (2 bytes)

Downstream Slow Minimum Data Rate:

Specifies the minimum downstream slow channel data rate in steps of 64K bits/s. The minimum aggregate downstream transmit speed of the line can be derived from the sum of minimum downstream fast and slow channel data rates. (R, W, Set-by-Create) (mandatory) (2 bytes)

Upstream Slow Maximum Data Rate:

Specifies the maximum upstream slow channel data rate in steps of 64K bits/s. The maximum aggregate upstream transmit speed of the line can be derived from the sum of maximum upstream fast and slow channel data rates. (R, W, Set-by-Create) (mandatory) (2 bytes)

Upstream Slow Minimum Data Rate:

Specifies the minimum upstream slow channel data rate in steps of 64K bits/s. The minimum aggregate upstream transmit speed of the line can be derived from the sum of minimum upstream fast and slow channel data rates. (R, W, Set-by-Create) (mandatory) (2 bytes)

Downstream Maximum Interleave Delay:

Specifies the maximum interleave delay, in milliseconds, for the downstream slow channel. Valid range is 0 to 255 ms. (R, W, Set-by-Create) (mandatory) (1 byte)

Upstream Maximum Interleave Delay:

Specifies the maximum interleave delay, in milliseconds, for the upstream slow channel. Valid range is 0 to 255 ms. (R, W, Set-by-Create) (mandatory) (1 byte)

Downstream Target Slow Burst:

Specifies the target level of impulse noise (burst) protection, in microseconds, for the downstream slow channel. Valid range is 0 to 1275 μs. (R, W, Set-by-Create) (mandatory) (2 bytes)

Upstream Target Slow Burst:

Specifies the target level of impulse noise (burst) protection, in microseconds, for the upstream slow channel. Valid range is 0 to 1275 μs. (R, W, Set-by-Create) (mandatory) (2 bytes)

Downstream Fast Maximum Data Rate:

Specifies the maximum downstream fast channel data rate in steps of 64K bits/s. (R, W, Set-by-Create) (mandatory) (2 bytes)

Downstream Fast Minimum Data Rate:

Specifies the minimum downstream fast channel data rate in steps of 64K bits/s. (R, W, Set-by-Create) (mandatory) (2 bytes)

Upstream Fast Maximum Data Rate:

Specifies the maximum upstream fast channel data rate in steps of 64K bits/s. (R, W, Set-by-Create) (mandatory) (2 bytes)

Upstream Fast Minimum Data Rate:

Specifies the minimum upstream fast channel data rate in steps of 64K bits/s. (R, W, Set-by-Create) (mandatory) (2 bytes)

Downstream Maximum Fast FEC:

This attribute provisions the maximum level of forward error correction (FEC) redundancy related overhead to be maintained, as a percentage for the downstream fast channel. Valid range is 0 to 50 percent. (R, W, Set-by-Create) (optional) (1 byte)

Upstream Maximum Fast FEC:

This parameter provisions the maximum level of forward error correction (FEC) redundancy related overhead to be maintained, as a percentage, for the upstream fast channel. Valid range is 0 to 50 percent. (R, W, Set-by-Create) (optional) (1 byte)

Actions

Create: Create an instance of this managed entity.

Delete: Delete an instance of this managed entity.

Get: Get one or more attributes.

Set: Set one or more attributes.

Notifications

None.

Managed Entity: VDSL Band Plan Configuration Profile

An instance of this managed entity represents a VDSL band plan configuration profile supported on the ONU. Zero or more VDSL physical path termination points can reference an instance of a VDSL band plan configuration profile managed entity. Instances of this managed entity are created and deleted by the ONU on request of the OLT.

Relationships

Zero or more instances of this managed entity are contained in an ONU. One or more instances of this managed entity are contained in an ONU containing instances of the physical path termination point VDSL UNI.

Attributes

Managed Entity ID:

This attribute provides a unique number for each instance of this managed entity. The value 0x00 is reserved. (R, Set-by-create) (mandatory) (2 bytes)

Band Plan:

The VDSL band plan to be used for the line is specified by this entity. BandPlan997(1) is to be used for ITU-T G.993.1 Bandplan-B, ETSI Bandplan, ANSI Plan 997. BandPlan998(2) is to be used for ITU-T G.993.1 Bandplan-A, ANSI plan 998. BandPlanFx(3) is to be used for ITU-T G.993.1 Bandplan-C. Other(4) is to be used for non-standard band plans. If this object is set to bandPlanFx(3), then band plan FX must also be set. (R, W, Set-by-Create) (mandatory) (1 byte)

Band Plan FX:

The frequency limit, in kHz, between bands D2 and U2 when the band plan is set to bandPlanFx(3). Valid range is 3,750 to 12,000 kHz. (R, W, Set-by-Create) (optional) (2 bytes)

Band Opt Usage:

Defines the VDSL link use of the optional frequency range [25 kHz-138 kHz] (Opt). The value unused(1) indicates opt is unused, upstream(2) indicates opt usage is for upstream, downstream(3) indicates opt usage is for downstream. (R, W, Set-by-Create) (mandatory) (1 byte)

Upstream PSD Template:

The upstream PSD template to be used for the line. Here, templateMask1 (1) refers to a notched mask that limits the transmitted PSD within the internationally standardized amateur radio bands, while templateMask2(2) refers to an unnotched mask. The masks themselves depend upon the applicable standard being used. (R, W, Set-by-Create) (mandatory) (1 byte)

Downstream PSD Template:

The downstream PSD template to be used for the line. Here, templateMask1 (1) refers to a notched mask that limits the transmitted PSD within the internationally standardized handheld amateur radio bands, while templateMask2(2) refers to an unnotched mask. The masks themselves depend upon the applicable standard being used. (R, W, Set-by-Create) (mandatory) (1 byte)

Amateur Band Mask:

The transmit power spectral density mask code, used to avoid interference with handheld amateur radio bands by introducing power control (notching) in one or more of these bands. Amateur radio band notching is defined in the VDSL spectrum as follows:

| Band | Start Frequency | Stop Frequency |
|---|---|---|
| 30 m | 1810 kHz | 2000 kHz |
| 40 m | 3500 kHz | 3800 kHz (ETSI); 4000 kHz (ANSI) |
| 80 m | 7000 kHz | 7100 kHz (ETSI); 7300 kHz (ANSI) |
| 160 m | 10100 kHz | 10150 kHz |

Notching for each standard band can be enabled or disabled via this bit mask. Two custom notches may be specified. If customNotch1 is enabled, then both custom notch 1 start and custom notch 2 stop must be specified. If customNotch2 is enabled, then both custom notch 2 start and custom notch 2 stop must be specified. Valid bit values are defined as follows, all combinations are allowed:

customNotch1(0)—custom (region-specific) notch

customNotch2(1)—custom (region-specific) notch

amateurBand30m(2)—amateur radio band notch

amateurBand40m(3)—amateur radio band notch

amateurBand80m(4)—amateur radio band notch

amateurBand160m(5)—amateur radio band notch

(R, W, Set-by-Create) (mandatory) (1 byte)

Custom Notch 1 Start:

Specifies the start frequency, in kHz, of custom handheld amateur radio notch 1. This field must be less than or equal to custom notch 1 stop. Valid range is 0 to 65,535 kHz. (R, W, Set-by-Create) (optional) (2 bytes)

Custom Notch 1 Stop:

Specifies the stop frequency, in kHz, of custom handheld amateur radio notch 1. This field must be greater than or equal to custom notch 1 start. Valid range is 0 to 65,535 kHz. (R, W, Set-by-Create) (optional) (2 bytes)

Custom Notch 2 Start:

Specifies the start frequency, in kHz, of custom handheld amateur radio) notch 2. This field must be less than or equal to custom notch 2 stop. Valid range is 0 to 65,535 kHz. (R, W, Set-by-Create) (optional) (2 bytes)

Custom Notch 2 Stop:

Specifies the stop frequency, in kHz, of custom handheld amateur radio notch 2. This field must be greater than or equal to custom notch2 start. Valid range is 0 to 65,535 kHz. (R, W, Set-by-Create) (optional) (2 bytes)

Deployment Scenario:

The VDSL line deployment scenario. When using fttCab(1), the VTU-C is located in a street cabinet. When using fttEx(2), the VTU-C is located at the central office. Changes to this value will have no effect on the transceiver. (R, W, Set-by-Create) (mandatory) (1 byte)

ADSL Presence:

Indicates presence of ADSL service in the associated cable bundle/binder. none(1) indicates no ADSL service in the bundle, adslOverPots(2) indicates ADSL service over POTS is present in the bundle, adslOverISDN(3) indicates ADSL service over ISDN is present in the bundle. (R, W, Set-by-Create) (mandatory) (1 byte)

Applicable Standard:

The VDSL standard to be used for the line. The value ansi(1) indicates the ANSI standard, etsi(2) indicates the ETSI standard, itu(3) indicates the ITU standard, other(4) indicates a standard other than the above. (R, W, Set-by-Create) (mandatory) (1 byte)

Actions

Create: Create an instance of this managed entity.

Delete: Delete an instance of this managed entity.

Get: Get one or more attributes.

Set: Set one or more attributes.

Notifications

None.

Managed Entity: VDSL VTU-O Physical Interface Monitoring History Data

This managed entity contains the last completed 15-minute interval collected statistic data for a VDSL physical interface. Instances of this managed entity are created/deleted by the OLT after an instance of the physical path termination point VDSL UNI managed entity is created/deleted. The performance management of the physical interfaces used by VDSL are supported. Failure/notifications should include threshold alerts for unacceptable performance (error) rates. Performance data should include transmission counts of errored seconds (ES), severely errored seconds (SES) and unavailable seconds (UAS).

Relationships

One instance of this managed entity can exist for each instance of the physical path termination point VDSL UNI.

Attributes

Managed Entity ID:

This attribute provides a unique number for each instance of this managed entity. This 2-byte number is directly associated with the physical position of the UNI. The first byte is the slot ID. The second byte is the port ID with a value range from 0x01 to 0xFF (1 to 255). (R, W, Set-by-create) (mandatory) (2 bytes)

Interval End Time:

This attribute identifies the most recently finished 15-minute interval. It is a cyclic counter (modulo 0xFF (256)) that is incremented each time a new interval is finished and the attribute counters are updated. The value of this attribute is 0x00 during the first 15-minute interval that starts with the reception of the “synchronize time” action. The value is 0x01 during the first period after this, and so on. If this managed entity is created after the reception of the “synchronize time” action, the value of this attribute is set equal to the number of the last completed interval. The actual counters of this managed entity start counting directly. The attribute counters are updated at the end of the interval. (R) (mandatory) (1 byte)

Threshold Data _{B-PON} ID:

This attribute provides a pointer to an instance of the threshold data _{B-PON} managed entity that contains the threshold values for the performance monitoring data collected by this managed entity. (R, W, Set by-create) (mandatory) (2 bytes)

Loss of Framing Seconds:

Count of seconds during this interval that there was loss of framing. (R) (mandatory) (2 bytes)

Loss of Signal Seconds:

Count of seconds during this interval that there was loss of signal. (R) (mandatory) (2 bytes)

Loss of Power Seconds:

Count of seconds during this interval that there was loss of power. (R) (mandatory) (2 bytes)

Loss of Link Seconds:

Count of seconds during this interval that there was loss of link. (R) (mandatory) (2 bytes)

Errored Seconds:

Count of errored seconds during this interval. An errored second is a one-second interval containing one or more CRC anomalies, or one or more loss of signal or loss of framing defects. (R) (mandatory) (2 bytes)

Severely Errored Seconds:

Count of severely errored seconds during this interval. (R) (mandatory) (2 bytes)

Unavailable Seconds:

Count of unavailable seconds during this interval. (R) (mandatory) (2 bytes)

Line Initializations:

Count of the line initialization attempts during this interval. This count includes both successful and failed attempts. (R) (mandatory) (2 bytes)

Actions

Create: Create an instance of this managed entity.

Delete: Delete an instance of this managed entity.

Get: Get one or more attributes.

Get Current Data: Get the current value of one or more attributes.

Set: Set one or more attributes.

Notifications

Threshold Crossing Alert:

This notification is used to notify the network management system when a threshold crossing alert (TCA) is detected or cleared. The TCA change notification “on” is sent at the crossing of the threshold by the actual counter; the TCA change notification “off” is sent at the end of the 15 min period since that is when the actual counters are reset to 0x00. Both the ONU and OLT should know the event list used by this entity. The list of TCAs for this entity is given in Table 13.

TABLE 13

| | Event | | |
|---|---|---|---|
| | Threshold | | Threshold Data |
| Number | Crossing Alert | Description | Counter Number* |
| 0 | LOFS | Exceeds threshold | 1 |
| 1 | LOSS | Exceeds threshold | 2 |
| 2 | LOLS | Exceeds threshold | 3 |
| 3 | LOPS | Exceeds threshold | 4 |
| 4 | ES | Exceeds threshold | 5 |
| 5 | LI | Exceeds threshold | 6 |
| 6 | SES | Exceeds threshold | 7 |
| 7 | UAS | Exceeds threshold | 8 |
| 8-255 | Reserved | | |

*This numbering is used with the associated threshold data _{B-PON} managed entity. Threshold data counter 1 indicates the 1^{st} thresholded counter, etc.

Managed Entity: VDSL VTU-R Physical Interface Monitoring History Data

This managed entity contains the last completed 15-minute interval collected statistic data for a VDSL physical interface. Instances of this managed entity are created/deleted by the OLT after an instance of the physical path termination point VDSL UNI managed entity is created/deleted. The performance management of the physical interfaces used by VDSL are supported. Failure/notifications should include threshold alerts for unacceptable performance (error) rates. Performance data should include transmission counts of errored seconds (ES), severely errored seconds (SES) and unavailable seconds (UAS).

Relationships

One instance of this managed entity can exist for each instance of the physical path termination point VDSL UNI.

Attributes

Managed Entity ID:

This attribute provides a unique number for each instance of this managed entity. This 2-byte number is directly associated with the physical position of the UNI. The first byte is the slot ID. The second byte is the port ID with a value range from 0x01 to 0xFF (1 to 255). (R, W, Set-by-create) (mandatory) (2 bytes)

Interval End Time:

This attribute identifies the most recently finished 15-minute interval. It is a cyclic counter (modulo 0xFF (256)) that is incremented each time a new interval is finished and the attribute counters are updated. The value of this attribute is 0x00 during the first 15-minute interval that starts with the reception of the “synchronize time” action. The value is 0x01 during the first period after this, and so on. If this managed entity is created after the reception of the “synchronize time” action, the value of this attribute is set equal to the number of the last completed interval. The actual counters of this managed entity start counting directly. The attribute counters are updated at the end of the interval. (R) (mandatory) (1 byte)

Threshold Data _{B-PON} ID:

This attribute provides a pointer to an instance of the threshold data _{B-PON} managed entity that contains the threshold values for the performance monitoring data collected by this managed entity. (R, W, Set by-create) (mandatory) (2 bytes)

Loss of Framing Seconds:

Count of seconds during this interval that there was loss of framing. (R) (mandatory) (2 bytes)

Loss of Signal Seconds:

Count of seconds during this interval that there was loss of signal. (R) (mandatory) (2 bytes)

Loss of Power Seconds:

Count of seconds during this interval that there was loss of power. (R) (mandatory) (2 bytes)

Loss of Link Seconds:

Count of seconds during this interval that there was loss of link. (R) (mandatory) (2 bytes)

Errored Seconds:

Count of errored seconds during this interval. An errored second is a one-second interval containing one or more CRC anomalies, or one or more loss of signal or loss of framing defects. (R) (mandatory) (2 bytes)

Severely Errored Seconds:

Count of severely errored seconds during this interval. (R) (mandatory) (2 bytes)

Unavailable Seconds:

Count of unavailable seconds during this interval. (R) (mandatory) (2 bytes)

Actions

Create: Create an instance of this managed entity.

Delete: Delete an instance of this managed entity.

Get: Get one or more attributes.

Get Current Data: Get the current value of one or more attributes.

Set: Set one or more attributes.

Notifications

Threshold Crossing Alert:

This notification is used to notify the network management system when a threshold crossing alert (TCA) is detected or cleared. The TCA change notification “on” will be sent at the crossing of the threshold by the actual counter; the TCA change notification “off” will be sent at the end of the 15 min period since that is when the actual counters are reset to 0x00. Both the ONU and OLT should know the event list used by this entity. The list of TCAs for this entity is given in Table 14.

TABLE 14

| | Event | | |
|---|---|---|---|
| | Threshold | | Threshold Data |
| Number | Crossing Alert | Description | Counter Number* |
| 0 | LOFS | Exceeds threshold | 1 |
| 1 | LOSS | Exceeds threshold | 2 |
| 2 | LOLS | Exceeds threshold | 3 |
| 3 | LOPS | Exceeds threshold | 4 |
| 4 | ES | Exceeds threshold | 5 |
| 5 | SES | Exceeds threshold | 6 |
| 6 | UAS | Exceeds threshold | 7 |
| 7-255 | Reserved | | |

*This numbering is used with the associated threshold data _{B-PON} managed entity. Threshold data counter 1 indicates the 1^{st} thresholded counter, etc.

Managed Entity: VDSL VTU-O Channel Performance Monitoring History Data

This managed entity contains the last completed 15-minute interval collected statistic data for both fast and slow VDSL channels, as seen from the VTU-O. Instances of this managed entity are created/deleted by the OLT after an instance of the physical path termination point VDSL UNI managed entity is created/deleted.

Relationships

One instance of this managed entity can exist for each instance of the physical path termination point VDSL UNI.

Attributes

Managed Entity ID:

This attribute provides a unique number for each instance of this managed entity. This 2-byte number is directly associated with the physical position of the UNI. The first byte is the slot ID. The second byte is the port ID with a value range from 0x01 to 0xFF (1 to 255). (R, W, Set-by-create) (mandatory) (2 bytes)

Interval End Time:

This attribute identifies the most recently finished 15 minute interval. It is a cyclic counter (modulo 0xFF (256)) that is incremented each time a new interval is finished and the attribute counters are updated. The value of this attribute is 0x00 during the first 15-minute interval that starts with the reception of the “synchronize time” action. The value is 0x01 during the first period after this, and so on. If this managed entity is created after the reception of the “synchronize time” action, the value of this attribute is set equal to the number of the last completed interval. The actual counters of this managed entity start counting directly. The attribute counters are updated at the end of the interval. (R) (mandatory) (1 byte)

Threshold Data _{B-PON} ID:

This attribute provides a pointer to an instance of the threshold data _{B-PON} managed entity that contains the threshold values for the performance monitoring data collected by this managed entity. (R, W, Set by-create) (mandatory) (2 bytes)

Fast Channel Corrected Blocks:

This attribute is the count of all blocks received by the VTU-O with errors that were corrected on the fast channel within the previous 15-minute interval. (R) (mandatory) (4 bytes)

Fast Channel Bad Blocks:

This attribute is the count of all blocks received by the VTU-O with uncorrectable errors on the fast channel within the previous 15-minute interval. (R) (mandatory) (4 bytes)

Fast Channel Transmitted Blocks:

This attribute is the count of all blocks transmitted by the VTU-O on the fast channel within the previous 15-minute interval. (R) (mandatory) (4 bytes)

Fast Channel Received Blocks:

This attribute is the count of all blocks received by the VTU-O on the fast channel within the previous 15-minute interval. (R) (mandatory) (4 bytes)

Slow Channel Corrected Blocks:

This attribute is the count of all blocks received by the VTU-O with errors that were corrected on the slow channel within the previous 15-minute interval. (R) (mandatory) (4 bytes)

Slow Channel Bad Blocks:

This attribute is the count of all blocks received by the VTU-O with uncorrectable errors on the slow channel within the previous 15-minute interval. (R) (mandatory) (4 bytes)

Slow Channel Transmitted Blocks:

This attribute is the count of all blocks transmitted by the VTU-O on the slow channel within the previous 15-minute interval. (R) (mandatory) (4 bytes)

Slow Channel Received Blocks:

This attribute is the count of all blocks received by the VTU-O on the slow channel within the previous 15-minute interval. (R) (mandatory) (4 bytes)

Actions

Create: Create an instance of this managed entity.

Delete: Delete an instance of this managed entity.

Get: Get one or more attributes.

Get Current Data: Get the current value of one or more attributes.

Set: Set one or more attributes.

Notifications

Threshold Crossing Alert:

This notification is used to notify the network management system when a threshold crossing alert (TCA) is detected or cleared. The TCA change notification “on” will be sent at the crossing of the threshold by the actual counter; the TCA change notification “off” will be sent at the end of the 15 min period since that is when the actual counters are reset to 0x00. Both ONU and OLT should know the event list used by this entity. The list of TCAs for this entity is given in Table 15.

TABLE 15

| | Event | | |
|---|---|---|---|
| | Threshold Crossing | | Threshold Data |
| Number | Alert | Description | Counter Number* |
| 0 | FCCB | Exceeds threshold | 1 |
| 1 | FCBB | Exceeds threshold | 2 |
| 2 | SCCB | Exceeds threshold | 3 |
| 3 | SCBB | Exceeds threshold | 4 |
| 4-255 | Reserved | | |

*This numbering is used with the associated threshold data _{B-PON} managed entity. Threshold data counter 1 indicates the 1^{st} thresholded counter, etc.

Managed Entity: VDSL VTU-R Channel Performance Monitoring History Data

This managed entity contains the last completed 15-minute interval collected statistic data for both fast and slow VDSL channels, as seen from the VTU-R. Instances of this managed entity are created/deleted by the OLT after an instance of the physical path termination point VDSL UNI managed entity is created/deleted.

Relationships

One instance of this managed entity can exist for each instance of the physical path termination point VDSL UNI.

Attributes

Managed Entity ID:

This attribute provides a unique number for each instance of this managed entity. This 2-byte number is directly associated with the physical position of the UNI. The first byte is the slot ID. The second byte is the port ID with a value range from 0x01 to 0xFF (1 to 255). (R, W, Set-by-create) (mandatory) (2 bytes)

Interval End Time:

This attribute identifies the most recently finished 15-minute interval. It is a cyclic counter (modulo 0xFF (256)) that is incremented each time a new interval is finished and the attribute counters are updated. The value of this attribute is 0x00 during the first 15-minute interval that starts with the reception of the “synchronize time” action. The value is 0x01 during the first period after this, and so on. If this managed entity is created after the reception of the “synchronize time” action, the value of this attribute is set equal to the number of the last completed interval. The actual counters of this managed entity start counting directly. The attribute counters are updated at the end of the interval. (R) (mandatory) (1 byte)

Threshold Data _{B-PON} ID:

This attribute provides a pointer to an instance of the threshold data _{B-PON} managed entity that contains the threshold values for the performance monitoring data collected by this managed entity. (R, W, Set by-create) (mandatory) (2 bytes)

Fast Channel Corrected Blocks:

This attribute is the count of all blocks received by the VTU-R with errors that were corrected on the fast channel within the previous 15-minute interval. (R) (mandatory) (4 bytes)

Fast Channel Bad Blocks:

This attribute is the count of all blocks received by the VTU-R with uncorrectable errors on the fast channel within the previous 15-minute interval. (R) (mandatory) (4 bytes)

Fast Channel Transmitted Blocks:

This attribute is the count of all blocks transmitted by the VTU-R on the fast channel within the previous 15-minute interval. (R) (mandatory) (4 bytes)

Fast Channel Received Blocks:

This attribute is the count of all blocks received by the VTU-R on the fast channel within the previous 15-minute interval. (R) (mandatory) (4 bytes)

Slow Channel Corrected Blocks:

This attribute is the count of all blocks received by the VTU-R with errors that were corrected on the slow channel within the previous 15-minute interval. (R) (mandatory) (4 bytes)

Slow Channel Bad Blocks:

This attribute is the count of all blocks received by the VTU-R with uncorrectable errors on the slow channel within the previous 15-minute interval. (R) (mandatory) (4 bytes)

Slow Channel Transmitted Blocks:

This attribute is the count of all blocks transmitted by the VTU-R on the slow channel within the previous 15-minute interval. (R) (mandatory) (4 bytes)

Slow Channel Received Blocks:

This attribute is the count of all blocks received by the VTU-R on the slow channel within the previous 15-minute interval. (R) (mandatory) (4 bytes)

Actions

Create: Create an instance of this managed entity.

Delete: Delete an instance of this managed entity.

Get: Get one or more attributes.

Get Current Data: Get the current value of one or more attributes.

Set: Set one or more attributes.

Notifications

Threshold Crossing Alert:

This notification is used to notify the network management system when a threshold crossing alert (TCA) is detected or cleared. The TCA change notification “on” will be sent at the crossing of the threshold by the actual counter; the TCA change notification “off” will be sent at the end of the 15 min period since that is when the actual counters are reset to 0x00. Both the ONU and OLT should know the event list used by this entity. The list of TCAs for this entity is given in Table 16.

TABLE 16

| | Event | | |
|---|---|---|---|
| | Threshold | | Threshold Data |
| Number | Crossing Alert | Description | Counter Number* |
| 0 | FCCB | Exceeds | 1 |
| | | threshold | |
| 1 | FCBB | Exceeds | 2 |
| | | threshold | |
| 2 | SCCB | Exceeds | 3 |
| | | threshold | |
| 3 | SCBB | Exceeds | 4 |
| | | threshold | |
| 4-255 | Reserved | | |

*This numbering is used with the associated threshold data _{B-PON} managed entity. Threshold data counter 1 indicates the 1^{st} thresholded counter, etc.

An apparatus and process have been described as useful for managing and controlling a PON ONT for digital subscriber line interfaces. Specific applications and exemplary embodiments of the invention have been illustrated and discussed, which provide a basis for practicing the invention in a variety of ways and in a variety of network applications. Numerous variations are possible within the scope of the invention. Features and elements associated with one or more of the described embodiments are not to be construed as required elements for all embodiments. The invention is limited only by the claims that follow.

1. A method for managing a network providing data services to a subscriber, wherein the network comprises an OLT and an ONU connected to the OLT via a passive optical network, wherein the ONU is connected to the subscriber through an xDSL connection, the method comprising:
providing a plurality of managed entities for managing the ONU, wherein the plurality of managed entities further comprise ADSL managed entities for managing an ADSL connection between the ONU and the subscriber, and VDSL managed entities for managing a VDSL connection between the ONU and the subscriber;
managing the network through one or more of the plurality of managed entities; and
communicating data and network management information between the OLT and the ONU in response to the managed entities.

2. The method of claim 1 wherein the step of communicating the data and the network management information further comprises communicating the data and the network management information over the passive optical network.

3. The method of claim 1 wherein each one of the plurality of managed entities further comprises one or more network attributes, each network attribute associated with a network feature.

4. The method of 3 wherein network attributes associated with related network features are included within a single managed entity.

5. The method of claim 4 wherein the network attributes associated with related network features included within a single ADSL managed entity comprise one or more of channel performance monitoring history data, ATU-C and ATU-R performance monitoring history data, channel configuration profile, channel downstream status data, channel upstream status data, a downstream PSD mask profile, a downstream RFI bands profile, a subcarrier masking downstream profile, a subcarrier masking upstream profile, threshold crossing adaptor performance monitoring history data.

6. The method of claim 4 wherein the network attributes associated with related network features included within a single VDSL managed entity comprise one or more of physical path termination point VDSL UNI, band plan configuration profile, channel configuration profile, channel data, line configuration profile, VTU-O and VTU-R channel performance monitoring history data, VTU-O and VTU-R physical data, VTU-O and VTU-R physical interface monitoring history data.

7. The method of claim 3 wherein network attributes define operational parameters of one or more of the OLT, the ONU, the passive optical network, the ADSL connection and the VDSL connection, and wherein network attributes associated with related network features are included within a single managed entity.

8. The method of claim 3 wherein network attributes associated with related network features are included within a plurality of associated managed entities.

9. The method of claim 8 wherein the plurality of associated managed entities comprise managed entities related to one or more of an ADSL line configuration profile, ADSL line inventory and status data and physical path termination point ADSL UNI.

10. The method of claim 1 wherein each managed entity is represented by a fixed number of data bytes.

11. (canceled)

12. The method of claim 1 wherein each one of the plurality of managed entities is represented by a fixed number of data bits and comprises one or more network attributes selected from a plurality of network attributes, and wherein each network attribute is represented by data bits, and wherein the network attributes selected for inclusion within each one of the plurality of managed entities comprise network attributes associated with related network features and network attributes having a data bit sum less than or equal to the fixed number of data bits.

13. The method of claim 1 wherein the data services comprise telephone service, Internet data service, multimedia services and video services.

14. The method of claim 1 wherein the passive optical network comprises a broadband passive optical network or a gigabit passive optical network.

15. (canceled)

16. The method of claim 1 further comprising receiving network management requests from a network management system, wherein the step of managing the network is responsive to the network management requests.

17. The method of claim 1 further comprising creating a plurality of managed entities when an xDSL connection is activated.

18. The method of claim 1 wherein each managed entity comprises one or more of a relationships element, an attributes element, an actions element and a notifications element.

19. The method of claim 18 wherein the notifications element further comprises alarms, test results and attribute value changes.

20. The method of claim 1 wherein each one of the plurality of managed entities comprises network attributes, and wherein certain related network attributes are included in one managed entity and certain other related network attributes are included in at least two managed entities.

21. The method of claim 1 wherein the plurality of managed entities further comprise required managed entities and optional managed entities.

22. The method of claim 1 further comprising a plurality of subscribers and a plurality of ONU's, wherein each one of the plurality of ONU's is connected to subscribers through the xDSL connection, and wherein the step of communicating further comprises communicating data and network management information between the OLT and the plurality of ONU's in response to the managed entities.

23-65. (canceled)
